(19) United States
(12) Patent Application Publication
(10) Pub. No.: US 2024/0232902 A1
(43) Pub. Date: Jul. 11, 2024

(54) INFORMATION PROCESSING SYSTEM, METHOD, AND RECORDING MEDIUM

(71) Applicant: NEC Corporation, Minato-ku, Tokyo (JP)

(72) Inventor: Rumi Ikezawa, Tokyo (JP)

(73) Assignee: NEC Corporation, Minato-ku, Tokyo (JP)

(21) Appl. No.: 18/570,715

(22) PCT Filed: Jun. 21, 2021
(86) PCT No.: PCT/JP2021/023429

§ 371 Date: Dec. 15, 2023

(51) Int. Cl. G06Q 20/42; G06Q 20/40

(52) U.S. Cl. CPC G06Q 20/42; G06Q 20/407

(57) ABSTRACT

This information processing system has a reception unit and a settlement unit. The reception unit receives an input according to a predetermined confirmation after registering information of a commodity to be purchased by a customer has been finished by operation of the customer but before settlement for the commodity. The predetermined confirmation is required to be finished before settlement. After reception of the input according to the predetermined confirmation, the settlement unit makes settlement for the commodity. An operator of the input according to the predetermined confirmation is the customer if the confirmation is made by the customer and is a sales person if the confirmation is made by the sales person.

### TECHNICAL FIELD

The present disclosure relates to an information processing system and the like.

### BACKGROUND ART

There is a case where product registration and settlement are performed through an operation of a customer. For example, PTL 1 describes a technique for performing an age confirmation in a full self-checkout mode.

### CITATION LIST

### Patent Literature

PTL 1: JP 2021-026713 A

### SUMMARY OF INVENTION

### Technical Problem

In a case where product registration and settlement are performed through an operation of a customer, it may be required to confirm something. In such a case, it is preferable to perform the confirmation without trouble.

An object of the present disclosure is to provide an information processing system or the like capable of performing a predetermined confirmation without trouble before settlement.

### Solution to Problem

An information processing system according to an aspect of the present disclosure includes a reception means that receives an input corresponding to a predetermined confirmation after registration of information on products to be purchased by a customer is completed through an operation of the customer and before settlement for the registered products, and a settlement means that settles the registered products after the input corresponding to the predetermined confirmation is received.

A method according to an aspect of the present disclosure includes receiving an input corresponding to a predetermined confirmation after registration of information on products to be purchased by a customer is completed through an operation of the customer and before settlement for the registered products, and performing settlement for the registered products after the input corresponding to the predetermined confirmation is received.

A computer-readable recording medium according to an aspect of the present disclosure records a program for causing a computer to execute receiving an input corresponding to a predetermined confirmation after registration of information on products to be purchased by a customer is completed through an operation of the customer and before settlement for the registered products, and performing settlement for the registered products after the input corresponding to the predetermined confirmation is received.

### Advantageous Effects of Invention

According to the present disclosure, it is possible to perform a predetermined confirmation without trouble before settlement.

### BRIEF DESCRIPTION OF DRAWINGS

FIG. 1 is a block diagram illustrating an example of a configuration of an information processing system according to a first example embodiment.

FIG. 2 is a flowchart illustrating an example of an operation of the information processing system according to the first example embodiment.

FIG. 3 is an explanatory diagram illustrating an example of a checkout system according to a second example embodiment.

FIG. 4 is a block diagram illustrating an example of a configuration of the checkout device according to the second example embodiment.

FIG. 5 is a block diagram illustrating an example of a configuration of a server according to the second example embodiment.

FIG. 6 is a block diagram illustrating an example of a configuration of an attendant terminal device according to the second example embodiment.

FIG. 7 is an explanatory diagram illustrating an example of a screen for product registration.

FIG. 8 is an explanatory diagram illustrating an example of a screen related to a confirmation as to whether a product is to be eaten or drunk in a store.

FIG. 9 is an explanatory diagram illustrating an example of a screen for selecting whether to eat or drink each product in the store.

FIG. 10 is an explanatory diagram illustrating an example of a screen for selecting a settlement method.

FIG. 11 is a flowchart (part 1) illustrating an example of an operation of the checkout system for a confirmation regarding a change in tax rate according to the second example embodiment.

FIG. 12 is a flowchart (part 2) illustrating an example of an operation of the checkout system for a confirmation regarding a change in tax rate according to the second example embodiment.

FIG. 13 is an explanatory diagram illustrating an example of a screen related to a confirmation as to whether to use a bag that needs to be paid for.

FIG. 14 is a flowchart (part 1) illustrating an example of an operation of the checkout system for a confirmation regarding a bag or the like that needs to be paid for according to the second example embodiment.

FIG. 15 is a flowchart (part 2) illustrating an example of an operation of the checkout system for a confirmation regarding a bag or the like that needs to be paid for according to the second example embodiment.

FIG. 16 is an example of a screen showing a product-canceled status for each checkout device displayed on the attendant terminal device.

FIG. 17 is an explanatory diagram illustrating an example of a screen indicating that the store clerk is being called in a case where there is a canceled product.

FIG. 18 is an explanatory diagram illustrating an example of a screen for receiving an input of a confirmation code.

FIG. 19 is a flowchart (part 1) illustrating an example of an operation of the checkout system for a confirmation regarding collection of a canceled product according to the second example embodiment.

FIG. 20 is a flowchart (part 2) illustrating an example of an operation of the checkout system for a confirmation regarding collection of a canceled product according to the second example embodiment.

FIG. 21 is an explanatory diagram illustrating an example of a screen related to an age confirmation on the attendant terminal device.

FIG. 22 is an explanatory diagram illustrating an example of a screen indicating that the store clerk is being called in a case where an age confirmation product is registered.

FIG. 23 is an explanatory diagram illustrating an example of a screen for receiving an input of a confirmation code.

FIG. 24 is a flowchart (part 1) illustrating an example of an operation of the checkout system for a confirmation regarding an age according to the second example embodiment.

FIG. 25 is a flowchart (part 2) illustrating an example of an operation of the checkout system for a confirmation regarding an age according to the second example embodiment.

FIG. 26 is an explanatory diagram illustrating an example of a hardware configuration of a computer device.

### EXAMPLE EMBODIMENT

Hereinafter, example embodiments of a checkout system (an information processing system), a checkout device (an information processing device), a method, a program, and a non-transitory recording medium recording the program according to the present disclosure will be described in detail with reference to the drawings. These example embodiments do not limit the technology disclosed herein.

### First Example Embodiment

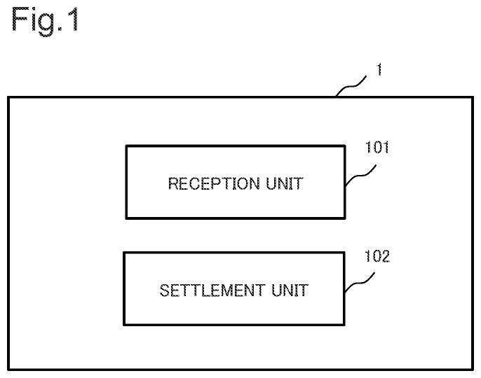

In a first example embodiment, a basic function of an information processing system according to the present disclosure will be described. FIG. 1 is a block diagram illustrating an example of a configuration of the information processing system according to the first example embodiment. The information processing system 1 has a reception unit 101 and a settlement unit 102.

The reception unit 101 receives an input corresponding to a predetermined confirmation before products to be purchased by a customer are settled after the customer completes an operation for registering information on the products. The timing after the registration of the information on the products is completed and before the settlement of the products is performed is, for example, a timing when the completion of the product registration by the customer is detected or a timing when a customer's expression of an intention to make a payment is detected, such as a timing when the customer presses a “payment” button. Note that such a timing is not limited to the timing when the customer presses a “payment” button.

Here, the predetermined confirmation is a confirmation that needs to be completed before settlement. The predetermined confirmation may be a confirmation performed by the customer. The confirmation performed by the customer includes a confirmation related to a use of a predetermined product such as a bag, a pair of chopsticks, a spoon, or a fork that needs to be paid for, a confirmation related to a purchase of a product of which a tax rate changes, and the like. The confirmation related to the purchase of the product of which the tax rate changes is, for example, a confirmation as to whether the registered product is to be eaten or drunk at the store, but is not limited thereto. The confirmation will be described in detail in the second example embodiment.

In addition, the predetermined confirmation may be a confirmation performed by a store clerk. The confirmation performed by the store clerk includes a confirmation as to whether a registration-canceled product has been collected, a confirmation regarding age at the time when a product requiring an age confirmation is purchased, or the like. The confirmation will be described in detail in the second example embodiment.

The method of the input corresponding to the predetermined confirmation is not particularly limited. For example, the reception unit 101 may receive an input to an input/output device such as a touch panel display. In addition, the reception unit 101 may receive an input to an input device such as a keyboard, a mouse, or a microphone.

After the reception of the input corresponding to the predetermined confirmation, the settlement unit 102 performs settlement for the products. The settlement method is not particularly limited. Note that the settlement method includes cash settlement, credit settlement, code settlement, point settlement, debit settlement, and the like.

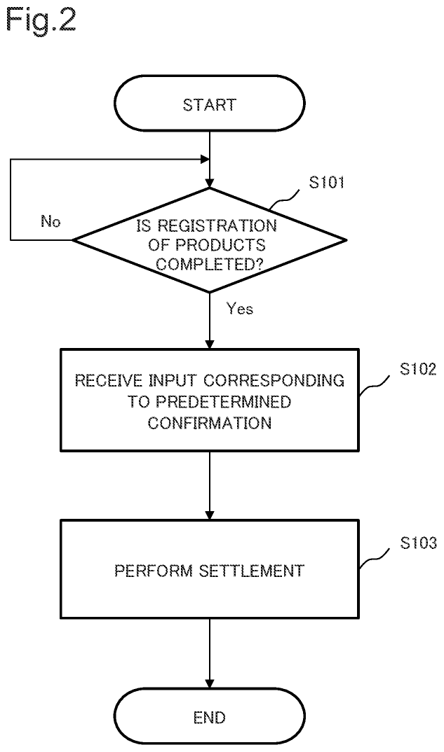

FIG. 2 is a flowchart illustrating an example of an operation of the information processing system 1 according to the first example embodiment. The reception unit 101 determines whether registration of products is completed step S101). In step S101, the reception unit 101 may determine that registration of products is completed when a “payment” button for shifting to a settlement process is pressed. When registration of products is not completed (step S101: No), the information processing system 1 returns to step S101. When registration of products is completed (step S101: Yes), the reception unit 101 receives an input corresponding to a predetermined confirmation (step S102). The input according to the predetermined confirmation is an input of a confirmation result. The person who performs the input corresponding to the predetermined confirmation differs depending on what is confirmed. For example, in a case where the confirmation is given by the customer, the input corresponding to the predetermined confirmation is performed by an operation of the customer. On the other hand, in a case where the confirmation is performed by the store clerk, the input corresponding to the predetermined confirmation is performed by an operation of the store clerk.

After the reception of the input corresponding to the predetermined confirmation, the settlement unit 102 performs a settlement (step S103). In step S103, the settlement unit 102 performs a settlement when a condition for starting the settlement is satisfied after the reception of the input corresponding to the predetermined confirmation. The condition for starting the settlement differs depending on, for example, what function the device including the settlement unit 102 has. For example, the condition for starting the settlement may be a state in which checkout information has been acquired, which will be described in the second example embodiment. Alternatively, the condition for starting the settlement may be a state in which a settlement method has been selected.

As described above, in the first example embodiment, the information processing system 1 displays a screen related to the predetermined confirmation after product registration and before settlement. Then, when receiving an input corresponding to the predetermined confirmation, the information processing system 1 performs a settlement. By doing so, after product registration and before settlement, a predetermined confirmation can be performed before settlement without trouble.

The first example embodiment is not limited to the examples described above, and various modifications can be made. In addition, each functional unit may be achieved by one device. Alternatively, each functional unit may be achieved by a plurality of devices. For example, the reception unit 101 and the settlement unit 102 may be different devices.

Furthermore, the store using the information processing system 1 is not particularly limited. For example, the store may be a store such as a supermarket, a super center, a convenience store, a mass retailer, a home center, or a drug store, or may be a store such as a private shop such as a bakery or a daily dish store.

### Second Example Embodiment

In the second example embodiment, as a predetermined confirmation, each of the confirmation performed by the customer and the confirmation performed by the store clerk will be described with specific examples. Furthermore, in the second example embodiment, an example in which a plurality of different confirmations are performed before settlement will be described. Next, the second example embodiment will be described in detail with reference to the drawings. Hereinafter, description overlapping with what has been described above will be omitted unless the omission obscures the description of the second example embodiment. In addition, in the second example embodiment, a checkout system will be described as an example of the information processing system.

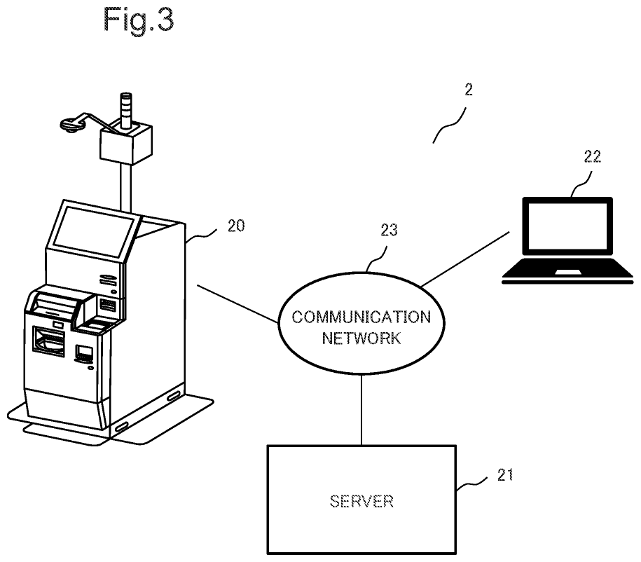

FIG. 3 is an explanatory diagram illustrating an example of a checkout system according to the second example embodiment. The checkout system 2 includes, for example, a checkout device 20, an attendant terminal device 22, and a server 21. The checkout device 20, the attendant terminal device 22, and the server 21 are connected to each other via a communication network 23.

The checkout device 20 is, for example, a device (an information processing device) that is operated by a customer to check out products to be purchased by the customer. Further, the checkout device 20 has, for example, a function as a product registration device that is operated by a customer to register information on products to be purchased by the customer.

The server 21 manages a product DB that stores information on products. In addition, the server 21 manages a list of products to be purchased by the customer (hereinafter referred to as a purchase product list). The product DB and the purchase product list will be described later.

The attendant terminal device 22 is an example of a terminal device of the store clerk. The attendant terminal device 22 is not particularly limited, and may be a personal computer (PC), a smartphone, a tablet terminal device, or the like. The attendant terminal device 22 manages, for example, a status of each checkout device 20. The attendant terminal device 22 may display a status for each checkout device 20 on a display device such as a display. Further, various kinds of information such as an error may be notified from each checkout device 20 to the attendant terminal device 22. In the second example embodiment, the checkout device 20 performs various notifications to the attendant terminal device 22 in a case where an age confirmation is necessary, in a case where a product collection is necessary, or the like. Then, the attendant terminal device 22 displays a screen related to these notifications. The notification timing and the like will be described later. In addition, the method of displaying a screen or the like is not particularly limited. By doing so, the store clerk can grasp which checkout device 20 requires an age confirmation or a product collection. A product requiring an age confirmation will hereinafter be referred to as an age confirmation product.

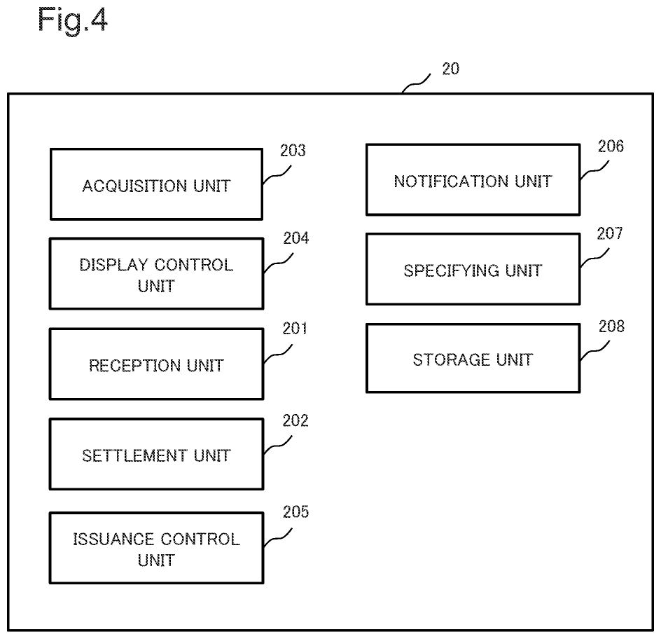

FIG. 4 is a block diagram illustrating an example of a configuration of the checkout device 20 according to the second example embodiment. The checkout device 20 includes an acquisition unit 203, a display control unit 204, a reception unit 201, a settlement unit 202, an issuance control unit 205, a notification unit 206, a specifying unit 207, and a storage unit 208. The reception unit 201 has the function of the reception unit 101 described in the first example embodiment as a basic function. In addition, the settlement unit 202 has the function of the settlement unit 102 described in the first example embodiment as a basic function.

The storage unit 208 stores, for example, data used for processing performed by each unit of the checkout device 20. The storage unit 208 stores, for example, a result of processing performed by each unit of the checkout device 20. Examples of the storage unit 208 include a read only memory (ROM), a random access memory (RAM), a semiconductor memory, a hard disk drive (HDD), and a solid state drive (SSD). The storage unit 208 may be a combination thereof. The storage unit 208 may be achieved by a plurality of devices connected to each other via the communication network 23. That is, the storage unit 208 may be arranged in a distributed manner.

The checkout device 20 may have a configuration including some of the functional units illustrated in FIG. 4. Alternatively, the checkout device 20 may include a functional unit that is not illustrated.

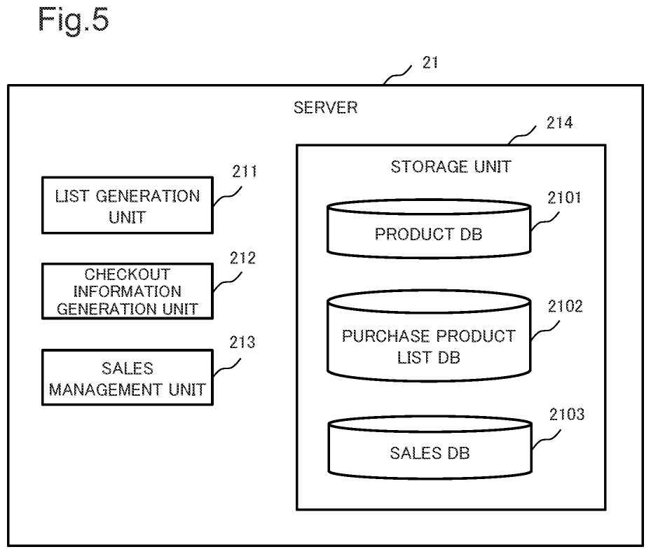

FIG. 5 is a block diagram illustrating an example of a configuration of the server 21 according to the second example embodiment. The server 21 includes a list generation unit 211, a checkout information generation unit 212, a sales management unit 213, and a storage unit 214. The storage unit 214 stores, for example, data used for processing performed by each unit of the server 21. The storage unit 214 stores, for example, a result of processing performed by each unit of the server 21. Examples of the storage unit 214 include a ROM, a RAM, a semiconductor memory, an HDD, and an SSD. The storage unit 214 may be a combination thereof. The storage unit 214 may be achieved by a plurality of devices connected to each other via the communication network 23.

The server 21 may have a configuration including some of the functional units illustrated in FIG. 5. Alternatively, the server 21 may include a functional unit that is not illustrated.

The storage unit 214 includes, for example, a product DB 2101, a purchase product list DB 2102, and a sales DB 2103.

The product DB 2101 stores information on products handled by the store or affiliated stores including the store. Hereinafter, the information on the products may be abbreviated as product information. Specifically, the product DB 2101 stores product information, for example, for each product type. The product information is, for example, information such as a product identifier (ID), a name of a product, a classification of a product, a price of a product, and a feature of a product. The product ID is an identifier capable of identifying a product. The product ID is not particularly limited. The product ID is, for example, a code of a product (hereinafter referred to as a product code). More specifically, the product ID may be, for example, a product code of at least one of a Japanese Article Number (JAN) code, a European Article Number (EAN) code, or a Universal Product Code (UPC). Alternatively, the product ID may be a name of the product. The classification of the product is not particularly limited. For example, the classification of the product may be a broad classification such as food and stationery. In addition, the classification of the product may be a narrow classification, such as confectionery, meat, and vegetable, divided from the broad classification. In addition, the classification of the product may be used to determine whether the product is subject to a reduced tax rate. The price of the product is how much the product is. The price of the product is a basic price of the product. The basic price is a price on which a tax-inclusive price, a succession amount, and a total amount is based when calculated. Hereinafter, the basic price will be referred to as a tax-exclusive price. In addition, the tax-inclusive price is a price obtained by imposing a consumption tax on the tax-exclusive price. The feature of the product is not particularly limited. The feature of the product may be information such as a best-before date, a use-by date, a manufacturer of the product, and the like.

In addition, the product information may include information for identifying the product in addition to the information on the product ID. For example, the product information may include image data of the product, information on a feature amount obtained from the image data of the product, and the like.

The product DB 2101 may include some of the above-described information regarding the product. Furthermore, the product DB 2101 may include information other than the above-described information regarding the product.

The purchase product list DB 2102 stores, for each customer, a latest purchase product list for which a settlement has not been completed. For example, the purchase product list stores, for each customer, information for identifying the customer, product information on products to be purchased by the customer, information on purchase quantities, and information for identifying whether to eat or drink in the store in association with each other. The information for identifying the customer is not particularly limited, for example, as long as it is capable of uniquely identifying the customer. For example, before registration of products for a new customer is started, a customer ID is given to the customer. When a membership ID such as a point card number is received, the membership ID may be used as a customer ID.

In addition, for example, the product ID may be included in information on a product registered in the purchase product list of the purchase product list DB 2102. By doing so, the checkout device 20 and the server 21 can obtain a price (a tax-exclusive price) of the product, a name of the product, and the like from the product DB 2101 according to the product ID registered in the purchase product list.

Here, the contents stored in the purchase product list can be variously changed depending on how the checkout system 2 is established. In the second example embodiment, an example in which the checkout information generation unit 212 of the server 21 calculates a total amount of tax-inclusive prices and the checkout device 20 displays a calculation result will be described. Note that the purchase product list may include, for each registered product type, a unit price and a purchase quantity, an applicable tax rate, and a tax-inclusive price for each tax rate. Therefore, the purchase product list DB 2102 may include some of the above-described information regarding the purchase product list. In addition, the purchase product list DB 2102 may include information other than the above-described information regarding the purchase product list.

The sales DB 2103 is, for example, information for each store regarding sales of the store. For example, the sales DB 2103 may manage information corresponding to each settlement for each store. Specifically, the sales DB 2103 stores, for example, information for identifying a store, information for identifying a customer, information for identifying a checkout device 20, information on a purchased product, a purchase quantity, and a purchase date and time in association with each other. The information for identifying a store is an identifier for uniquely identifying a store. The information for identifying a checkout device 20 registered in the sales DB 2103 is, for example, an identifier of a checkout device 20 that has performed a settlement. The information for identifying a customer registered in the sales DB 2103 may be the customer ID described above. Furthermore, the sales DB 2103 may include information included in each receipt as other information.

The sales DB 2103 may include some of the above-described information regarding the sales. Furthermore, the sales DB 2103 may include information other than the above-described information regarding the sales.

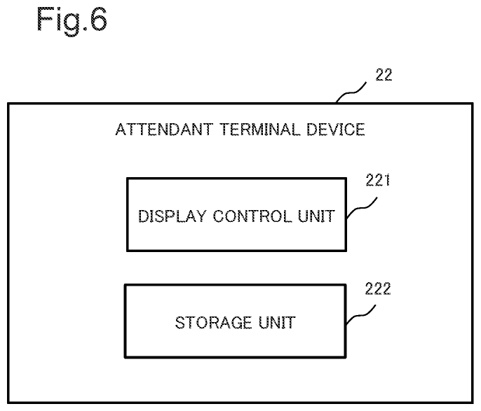

FIG. 6 is a block diagram illustrating an example of a configuration of the attendant terminal device 22 according to the second example embodiment. The attendant terminal device 22 includes a display control unit 221 and a storage unit 222. The storage unit 222 stores, for example, data used for processing performed by each unit of the attendant terminal device 22. The storage unit 222 stores, for example, a result of processing performed by each unit of the attendant terminal device 22. Examples of the storage unit 222 include a ROM, a RAM, a semiconductor memory, an HDD, and an SSD. The storage unit 222 may be a combination thereof. The storage unit 222 may be achieved by a plurality of devices connected to each other via the communication network 23. That is, the storage unit 222 may be arranged in a distributed manner.

The attendant terminal device 22 may have a configuration including some of the functional units illustrated in FIG. 6. Alternatively, the attendant terminal device 22 may include a functional unit that is not illustrated.

As described in the first example embodiment, there are various kinds of predetermined confirmations. Before each kind of confirmation is described in detail, registration of information on products will be described.

First, the acquisition unit 203 acquires information on products to be purchased by the customer. Specifically, the acquisition unit 203 acquires information on products to be purchased by the customer through an operation of the customer. The product information acquired here may be a product ID. The acquired product information may be image data of the product and information on a feature amount obtained from the image data of the product. The acquired product information is not limited thereto. The acquired product information may be any information as long as it is capable of uniquely specifying a product to be purchased by the customer. As a product information acquiring method, there are various examples such as reading a product code which is a product ID, identification through an image, and reading a tag. The acquisition method is not particularly limited.

For example, the acquisition unit 203 acquires the product information by reading the product code via a reading device. The product code may include the JAN code described above. In addition, the product code is represented by, for example, numbers, characters, or a combination thereof. When an encoded code such as a one-dimensional code or a two-dimensional code is attached to a product as a product code, the acquisition unit 203 acquires the encoded code. Then, the acquisition unit 203 decodes the encoded code. Then, acquisition unit 203 may transmit the decoded product code to the list generation unit 211 of the server 21. Alternatively, the acquisition unit 203 may transmit the read product code to the list generation unit 211 of the server 21. Then, the list generation unit 211 may decode the received product code.

In addition, the acquisition unit 203 acquires product information, for example, by identifying a product from an image of the product captured by an imaging device. In addition, the acquisition unit 203 identifies a product by reading an image of the product captured in advance or an image of a picture on the product via the imaging device. By doing so, the acquisition unit 203 acquires the product information. Note that such an image may include an encoded code such as a one-dimensional code or a two-dimensional code.

The acquisition unit 203 may acquire product information by reading a tag to which a radio frequency identifier (RFID) is attached via the reading device. When the RFID is used, the reading device is an RFID reader. The acquisition unit 203 is not limited to the RFID, and may acquire product information using short-range wireless communication or the like via the reading device.

In addition, the acquisition unit 203 may acquire product information by selecting the product information from a product search result. For example, the product search method is not particularly limited. The product search may be performed using characters. The product search may be performed using an image. More specifically, for example, the acquisition unit 203 may acquire product information by selecting a product to be purchased by the customer from the displayed image of the product.

In addition, the acquisition unit 203 may acquire product information by receiving an input of a product code represented by numbers or characters via the input device. Examples of the input device include a touch panel display and a keyboard capable of inputting numbers, characters, and the like.

Here, a process of registering product information will be described in detail using an example a product code attached to a product is read.

When acquiring a product code, the acquisition unit 203 transmits a request for registering a product associated to the product code to the server 21. For example, the registration request may include a customer ID, an ID of a checkout device 20, etc. in addition to the product code. When a transaction is started by a customer, the list generation unit 211 of the server 21 newly generates a purchase product list based on the registration request. In a case where there is already a purchase product list, the list generation unit 211 of the server 21 updates the purchase product list based on the registration request. That is, the list generation unit 211 functions as a registration unit that registers product information. When updating or generating the purchase product list, the list generation unit 211 transmits the purchase product list or information for identifying the purchase product list to the checkout device 20.

The display control unit 204 displays, on the display device, the product information registered in the purchase product list.

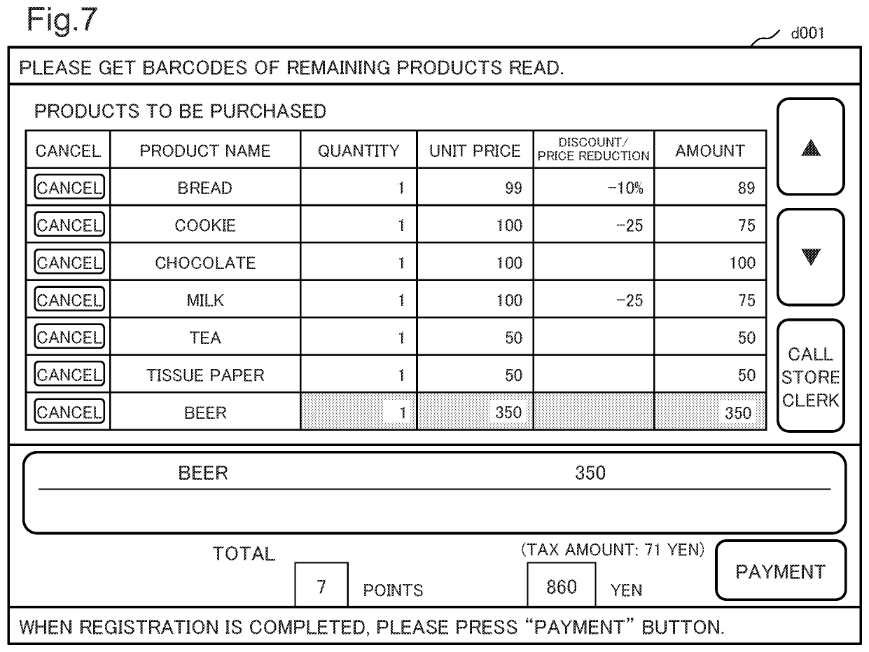

FIG. 7 is an explanatory diagram illustrating an example of a screen for product registration. The display control unit 204 displays screen d001 on the display device based on the product information registered in the purchase product list.

The screen d001 includes, for example, information for each registered product type on a name of the product, a purchase quantity of the product, a unit price of the product, a discount amount or a price reduction amount, and an amount of the product. In addition, the screen d001 includes information such as a total point of the products, a tax amount, and a total price including a tax.

Further, the screen d001 may include a “cancel” button for each product type. The cancellation of the product will be described later with confirmation regarding collection of the canceled product.

Further, the screen d001 may include various buttons such as a “call store clerk” button and a “payment” button. The “call store clerk” button is a button for calling a store clerk. The “payment” button is a button for shifting to payment after registering products. When the reception unit 201 receives a press of the “call store clerk” button, the notification unit 206 inform the store clerk. The method of notification performed by the notification unit 206 is not particularly limited. For example, the notification unit 206 may give a notification using an output to an output device such as a lamp or a buzzer included in the checkout device 20. Alternatively, the notification unit 206 may give a notification to the attendant terminal device 22 used by the store clerk or a terminal device possessed by the store clerk.

When the “payment” button is pressed, the checkout device 20 shifts to a settlement process. The customer presses the “payment” button. By doing so, the checkout device 20 can determine that registration of products to be purchased by the customer is completed. In the second example embodiment, the timing when the “payment” button is pressed is an example of the timing after product registration and before settlement.

After the customer completes an operation for registering information on products to be purchased by the customer, the display control unit 204 displays a screen related to a predetermined confirmation before settlement for the products. As described in the first example embodiment, there are various examples of predetermined confirmations. First, each functional unit will be described for each confirmation type. After each functional unit is described for each confirmation type, an example in which a plurality of different types of confirmations are performed will be described. The performing of the plurality of different types of confirmations means that a plurality of different types of confirmations are performed after the customer completes an operation for registering information on products to be purchased by the customer and before settlement for the products.

### [Confirmation Performed by Customer]

The confirmation performed by the customer includes a confirmation related to a purchase of a product of which a tax rate changes, a confirmation related to a purchase of a bag, a pair of chopsticks, a spoon, a fork, or the like that needs to be paid for, and the like.

### (Confirmation Regarding Change in Tax Rate)

For example, reduced tax rates may be introduced in some countries. For example, in Japan, as of May 25, 2021, the consumption tax rate is 8% (reduced tax rate) with respect to food and drink products excluding alcoholic beverages and in-store foods and drinks. On the other hand, the consumption tax rate is 10% (standard tax rate) with respect to alcoholic beverages and in-store foods and drinks among the food and drink products. Therefore, even for the same food and drink products, the tax rate is different between food and drink products eaten and drunk inside the store and food and drink products eaten and drunk outside the store. Since the tax rate is different between food and drink products eaten and drunk inside the store and food and drink products in the other cases, the food and drink products change in final prices. Therefore, the customer wants to confirm a purchase of a product of which a tax rate changes before settlement. That is, the customer wants to confirm whether the registered product is to be eaten or drunk in the store before settlement. Therefore, in the second example embodiment, whether to eat or drink the product in the store is confirmed after product registration and before settlement.

The display control unit 204 displays a screen related to a confirmation as to whether the registered product is to be eaten or drunk in the store after product registration and before settlement. The timing after product registration and before settlement is, for example, a timing when the “payment” button is pressed. Specifically, when the “payment” button is pressed, the display control unit 204 displays a screen related to a confirmation as to whether the registered product is to be eaten or drunk in the store. Whether the registered product is to be eaten or drunk in the store may be set for each product.

Here, the product DB 2101 may register whether each registered product is subject to a reduced tax rate. Alternatively, whether each registered product is subject to a reduced tax rate may be determined by the classification of the product in the product DB 2101. Furthermore, whether each product can be eaten or drunk in the store may be registered in the product DB 2101. Alternatively, whether each product can be eaten or drunk in the store may be determined by the classification of the product in the product DB 2101.

For example, a store such as a supermarket, a super center, or a home center may sell products that are subject to a reduced tax rate and products that are not subject to a reduced tax rate, such as products other than alcoholic beverages and food and drink products. Therefore, the specifying unit 207 specifies a candidate product that is subject to a reduced tax rate and can be eaten or drunk in the store, from among the products registered in the purchase product list. Then, the display control unit 204 may display a screen for confirming whether the candidate product is to be eaten or drunk in the store.

The candidate product may be a product designated in advance by the store clerk among food and drink products. For example, the store clerk may designate in advance whether each product can be eaten or drunk in the store, for example, by specifying that pasta is available only for take-out, but it can be selected whether pizza is to be taken out or eaten in the store or. In this case, the pizza is a candidate product, but the pasta is not a candidate product even though it is a food or beverage product.

Then, for example, the reception unit 201 receives an input for confirming a product to be eaten in the store through an operation of the customer. The input method is not particularly limited, as long as an input is performed via an input/output device or an input device. The input/output device is, for example, a touch panel display. The input device is, for example, a mouse, a keyboard, a physical button or switch, or the like.

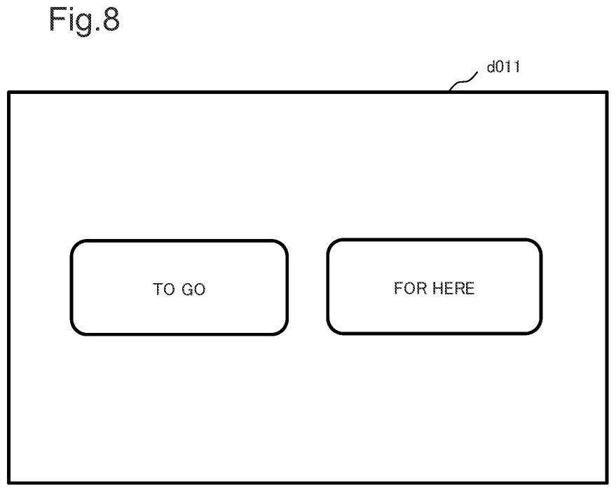

FIG. 8 is an explanatory diagram illustrating an example of a screen related to a confirmation as to whether a product is to be eaten or drunk in the store. Screen d011 includes, for example, a “for here” button for selecting an option for eating or drinking the product in the store and a “to go” button for selecting an option for not eating or drinking the product in the store. For example, when the “to go” button is pressed, the reduced tax rate is applied to all candidate products that are subject to the reduced tax rate. On the other hand, when the “for here” button is pressed, the reduced tax rate is not applied to all or some of the candidate products.

Whether the candidate products are to be eaten or drunk in the store or to be taken out may be selected collectively or individually. In a case where whether the candidate products are to be eaten or drunk in the store or to be taken out is selected collectively, the reception unit 201 receives a press of either the “for here” button or the “to go” button through an operation of the customer. For example, when the “for here” button is pressed, all the candidate products are excluded from the reduced tax rate. On the other hand, when the “to go” button is pressed, all the candidate products are subject to the reduced tax rate. By doing so, the reception unit 201 collectively receives an input corresponding to a confirmation as to whether the products are to be eaten or drunk in the store.

In addition, in a case where whether the candidate products are to be eaten or drunk in the store or to be taken out is selected for each product, the reception unit 201 receives a press of either the “for here” button or the “to go” button through an operation of the customer. Then, when a press of the “for here” button is received, the display control unit 204 may display a screen for individually selecting a product to be eaten in the store from among the candidate products. In addition, the display control unit 204 may display a screen on which it is possible to select whether each candidate product is to be eaten or drunk in the store or to be taken out, rather than displaying a screen on which the “for here” button or the “to go” button is selected, such as screen d011.

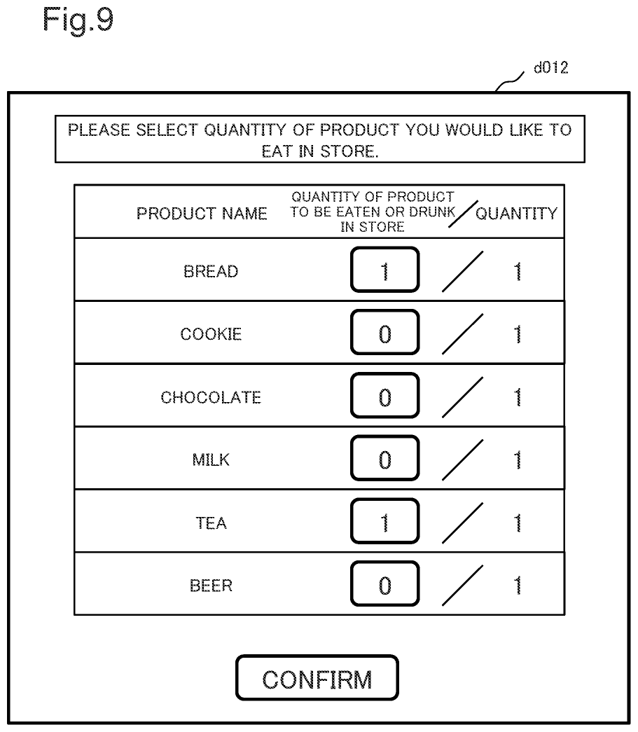

FIG. 9 is an explanatory diagram illustrating an example of a screen for selecting whether to eat or drink each product in the store. For example, screen d012 includes, for each candidate product type, information on a name of the product, a quantity of the product to be eaten or drunk in the store, and a quantity of the product registered in the purchase product list. In FIG. 9, beer is not subject to the reduced tax rate, but is displayed. In addition, in FIG. 9, screen d012 does not include information on tissue paper among the products illustrated in FIG. 7. For example, in a case where a quantity of a product to be eaten or drunk in the store is 0, the product is not eaten or drunk in the store. That is, the product is subject to the reduced tax rate. in a case where a quantity of a product to be eaten or drunk in the store is one or more, the product is eaten or drunk in the store. That is, as many as the quantity of the product to be eaten or drunk in the store are not subject to the reduced tax rate, and as many as the quantity of the product not to be eaten or drunk in the store, which is obtained by subtracting the quantity of the product to be eaten or drunk in the store from the purchase quantity, are subject to the reduced tax rate.

Through screen d012, the customer can easily input which product of the candidate products and how many pieces of the product are to be eaten or drunk in the store.

For example, the reception unit 201 receives an input of a quantity of a product to be eaten or drunk in the store for each product type. In FIG. 9, the quantity of bread to be eaten or drunk in the store is one, and the quantity of tea to be eaten or drunk in the store is one. In addition, the quantities of the other products to be eaten or drunk in the store are 0. Further, screen d012 may include a “confirm” button. Then, the reception unit 201 receives a press of the “confirm” button. When receiving a press of the “confirm” button, the reception unit 201 transmits the received information (hereinafter referred to as selection information) and a request for checkout information to the server 21. The selection information includes, for example, information on the product to be eaten or drunk in the store (e.g., the product ID) and information on the quantity of the product to be eaten or drunk in the store.

For example, based on the selection information, the purchase product list, and the product DB 2101, the checkout information generation unit 212 calculates a tax-excluded subtotal and a final price that is a total amount including a tax for all the products in the purchase product list. The checkout information generation unit 212 acquires a tax-exclusive price of the product from the product DB 2101 based on the information on the product included in the selection information. The server 21 may store information such as a standard tax rate (e.g., 10%) related to the consumption tax and a reduced tax rate (e.g., 8%) applied to some products in the storage unit 214 as tax rate information. Here, the standard tax rate is applied to products other than the products to which the reduced tax rate is applied. Among the products to which the reduced tax rate is applied, the standard tax rate is applied to the product selected as a product to be eaten or drunk in the store. Then, among the products to which the reduced tax rate is applied, the reduced tax rate is applied to the product that is not selected as a product to be eaten or drunk in the store. Whether or not the product is a product to which the reduced tax rate is applied may be specified by the classification of the product in the product DB 2101 or the like. As described above, among the products to which the reduced tax rate is applied, the product selected as a product to be eaten or drunk in the store is specified by the selection information.

For example, it is assumed that the basic price of the product is 192 yen. When this product is selected as a product to be eaten or drunk in the store, this product is subject to the standard tax rate (e.g., 10%), not subject to the reduced tax rate (e.g., 8%). Therefore, the checkout information generation unit 212 calculates, for example, 211 yen that is a price on which a 10% consumption tax is imposed as a tax-inclusive price of the product. Note that, in a case where this product is a product that is not to be eaten or drunk in the store, the reduced tax rate is applied to this product. Therefore, the checkout information generation unit 212 calculates, for example, 207 yen that is a price on which an 8% consumption tax is imposed as a tax-inclusive price of the product. Based on the calculated tax-inclusive price, the checkout information generation unit 212 calculates a tax-excluded subtotal and a total amount (a final price) including the tax for all the products in the purchase product list. Then, the checkout information generation unit 212 generates checkout information based on the final price. The checkout information includes, for example, at least final price information. In addition, the checkout information may include information on a tax-exclusive price and a subtotal for each product type to be purchased. The checkout information generation unit 212 transmits the checkout information to the checkout device 20. The tax-inclusive price calculation method and the final price calculation method are not particularly limited as long as an appropriate tax rate is applied to a tax-exclusive price of each product.

The purchase product list may include selection information received in association with the customer ID. In addition, the storage unit 214 may store the selection information separately from the purchase product list. In a case where the purchase product list includes a unit price, a purchase quantity, an applied tax rate, and a tax-inclusive price for each registered product type, the list generation unit 211 of the server 21 updates the applied tax rate based on the selection information and the tax rate information. Furthermore, the list generation unit 211 may update the tax-inclusive price. Thereafter, the checkout information generation unit 212 may generate checkout information based on the list generation unit 211 after being updated.

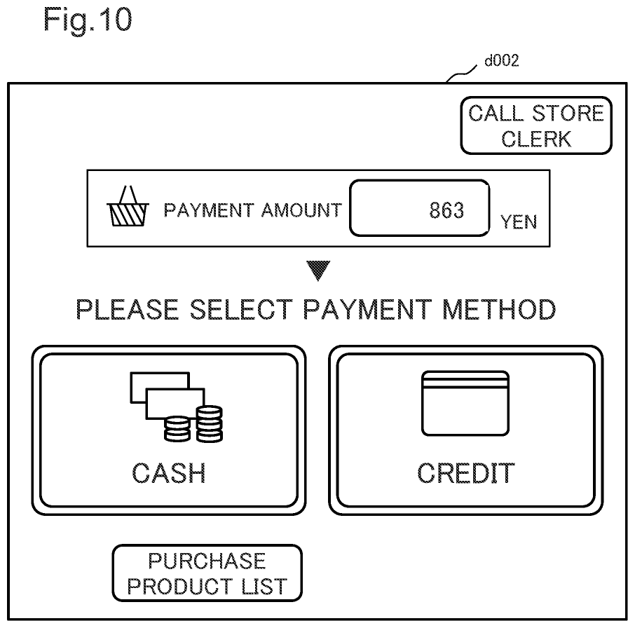

In addition, there may be a case where a settlement method can be selected. In a case where the settlement method can be selected, the reception unit 201 may transmit the selection information and a request for checkout information to the server 21 after the settlement method is selected. For example, in a case where the settlement method can be selected, the display control unit 204 displays a screen on which the settlement method can be selected. The settlement method is not particularly limited. The settlement method includes cash settlement, credit settlement, code settlement, point settlement, debit settlement, and the like. An example in which cash settlement and credit settlement can be selected is illustrated in FIG. 10.

FIG. 10 is an explanatory diagram illustrating an example of a screen for selecting a settlement method. Screen d002 includes a selection button capable of selecting an available settlement method. In addition, screen d002 includes a “cash” button and a “credit” button. The “cash” button is a button by which cash settlement can be selected. The “credit” button is a button by which credit settlement can be selected.

For example, the reception unit 201 receives a press of the “cash” button through an operation of the customer. By doing so, the reception unit 201 receives selection of cash settlement. On the other hand, for example, the reception unit 201 may receive a press of the “credit” button through an operation of the customer. By doing so, the reception unit 201 receives selection of credit settlement.

Screen d002 includes, for example, a “call store clerk” button and a “purchase product list” button. When the reception unit 201 receives a press of the “purchase product list” button, the display control unit 204 displays the above-described screen d001 illustrated in FIG. 7. When the reception unit 201 receives a press of the “call store clerk” button, the notification unit 206 notifies the store clerk. As described above, the method of notification performed by the notification unit 206 is not particularly limited.

In addition, the order in which screen d011, screen d012, and screen d002 are displayed is not particularly limited. That is, which of the confirmation and the selection of the settlement method is performed first is not particularly limited. As described above, after the confirmation is terminated through screen d011 and screen d012, the settlement method may be selected through screen d002.

Next, when receiving the checkout information, the display control unit 204 displays a screen related to a settlement. Then, the settlement unit 202 performs a settlement. Specifically, the settlement unit 202 performs a settlement when a condition for starting the settlement is satisfied after the reception of the input corresponding to the predetermined confirmation. As described in the first example embodiment, the condition may be reception of checkout information. Then, for example, the settlement unit 202 performs a settlement based on the checkout information. For the settlement, an existing technology may be used, and there is no particular limitation.

Furthermore, the issuance control unit 205 issues a receipt according to the settlement. The receipt may be an electronic receipt or a paper receipt.

In a case where the receipt is a paper receipt, the issuance control unit 205 issues the receipt through a printing device after the settlement is completed. Here, the printing device may be included, for example, in the checkout device 20. Alternatively, the printing device may be, for example, a device connected to the checkout device 20 via the communication network 23. Furthermore, the receipt may include, for example, purchase price information, membership information such as a membership ID, and information related to the store. The purchase price information included in the receipt is product information such as a product name and a product code for each product type, and information such as a product purchase quantity, a discount amount or a price reduction amount, a discount rate, whether a coupon is used, a tax-exclusive price, a tax-inclusive price, a total purchase price (a final price), a deposit amount, and a change amount. The information related to the store is, for example, a store name.

### (Example of Operation for Confirmation Regarding Change in Tax Rate)

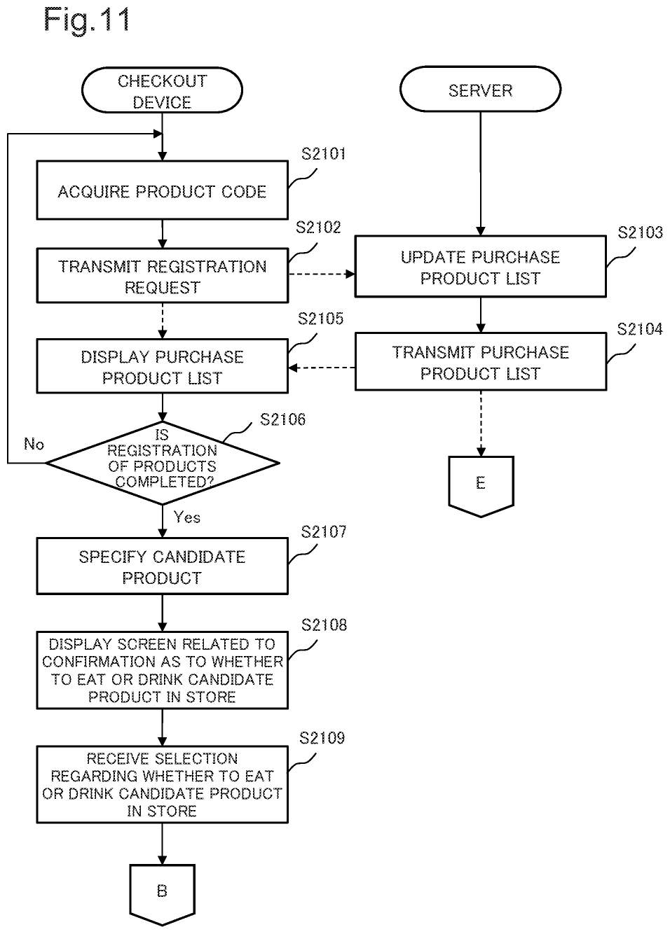

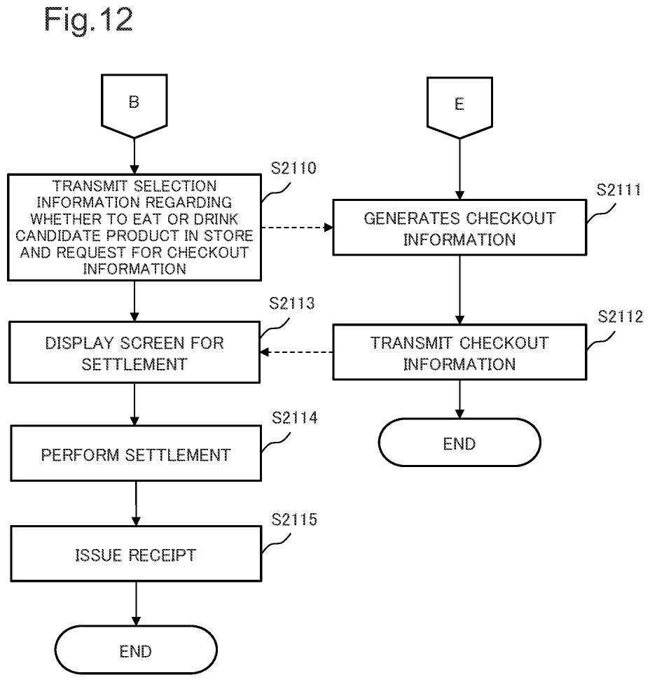

FIGS. 11 and 12 are flowcharts illustrating an example of an operation of the checkout system 2 for a confirmation regarding a change in tax rate according to the second example embodiment. The acquisition unit 203 acquires a product code from a product through an operation of the customer (step S2101). In step S2101, as described above, the method of the acquisition performed by the acquisition unit 203 is not particularly limited. As described above, the acquisition unit 203 acquires the product code as an example, but may acquire image data of the product or the like.

Then, the acquisition unit 203 transmits a registration request including the product code (step S2102). The list generation unit 211 updates the purchase product list based on the registration request (step S2103). The list generation unit 211 transmits the purchase product list (step S2104).

The display control unit 204 displays the purchase product list (step S2105). The reception unit 201 determines whether registration of products is completed (step S2106). In step S2106, the reception unit 201 may determine whether registration of products is completed depending on whether the “payment” button has been pressed through an operation of the customer. When registration of products is not completed (step S2106: No), the checkout system 2 returns to step S2101.

When registration of products is completed (step S2106: Yes), the specifying unit 207 specifies a candidate product that is subject to the reduced tax rate and can be eaten or drunk in the store based on the purchase product list (step S2107). Then, the display control unit 204 displays a screen related to a confirmation as to whether the candidate product is to be eaten or drunk in the store (step S2108).

The reception unit 201 receives a selection related to the confirmation as to whether the candidate product is to be eaten or drunk in the store (step S2109). As described above, the information received in step S2109 is selection information. As described above, the selection information includes, for example, information on the product to be eaten or drunk in the store (e.g., the product ID) and information on the quantity of the product to be eaten or drunk in the store. Then, the reception unit 201 transmits, to the server, the selection information regarding whether the candidate product is to be eaten or drunk in the store and a request for checkout information (step S2110). In a case where a settlement method can be selected, the reception unit 201 may receive a selection of the settlement method before step S2110 or the like.

The list generation unit 211 generates checkout information based on the selection information and the purchase product list (step S2111). The list generation unit 211 transmits the checkout information (step S2112). Next, the display control unit 204 displays a screen for settlement based on the checkout information (step S2113).

The settlement unit 202 performs a settlement (step S2114). Next, the issuance control unit 205 issues a receipt (step S2115). When the settlement is performed, the checkout device 20 may notify the server 21 that the settlement has been completed. Furthermore, the sales management unit 213 may update the sales DB 2103 based on the settlement.

(Confirmation Related to Use of Bag that Needs to be Paid for, Etc.)

First, a confirmation related to a purchase of a predetermined product will be described. The predetermined product is not particularly limited, and is, for example, a bag, a pair of chopsticks, a spoon, a fork, or a container that needs to be paid for. The bag (shopping bag), the spoon, the fork, the container, or the like may be required to be paid for. For example, in a case where a bag, a spoon, a fork, a container, or the like is manufactured of a predetermined material, it may be required to be paid for. In addition, in a case where a store operator or the like simply desires to charge a fee for a bag, a pair of chopsticks, a spoon, a fork, a container, or the like, it may be required to be paid for.

In this confirmation, the use of the bag, the pair of chopsticks, the spoon, or the fork is confirmed by an operation of the customer. The number of bags, chopsticks, spoons, forks, or the like required by the customer varies. For example, the number of bags or the like varies depending on what products are to be purchased by the customer. In addition, different types of bags, chopsticks, spoons, or forks may be provided. For example, concerning bags, the store may offer bags in different sizes. Therefore, in this confirmation regarding bags, the number of bags for each size may be confirmed. For example, concerning bags, the final price to be settled by the customer varies depending on whether to use a bag, the size of the bag, the number of bags, and the like. Therefore, the customer wants to perform this confirmation before settlement. Therefore, in the second example embodiment, after product registration and before settlement, a confirmation related to a use of a product such as a bag, a pair of chopsticks, a spoon, or a fork that needs to be paid for. The use of the bag, the spoon, the fork, or the like by the customer indicates that the bag, the spoon, the fork, or the like is purchased. In the following description, a bag will be used as an example.

The display control unit 204 displays a screen related to a confirmation as to whether to use a bag that needs to be paid for. Specifically, when the “payment” button is pressed, the display control unit 204 displays a screen related to this confirmation. The displayed screen may enable the customer to designate the number of bags. In a case where there are a plurality of types of bags that need to be paid, such as bags in different sizes or in different colors, the displayed screen may be a screen on which the number of bags to be used can be confirmed for each type.

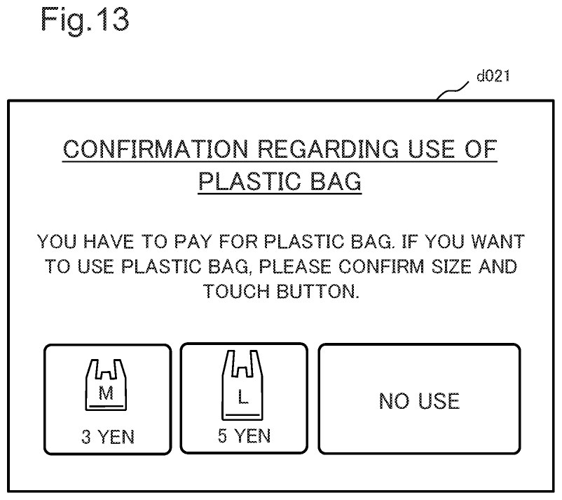

FIG. 13 is an explanatory diagram illustrating an example of a screen related to a confirmation as to whether to use a bag that needs to be paid for. Screen d021 may include a message or the like related to a use of a bag. On screen d021 of FIG. 13, the plastic bag is a bag that needs to be paid. In FIG. 13, screen d021 includes a button for using a “5-yen bag”, a button for using a “3-yen bag”, and a button for “no use”. When the button for “no use” is pressed, the reception unit 201 receives an input indicating that any type of bag is not to be used.

When the reception unit 201 receives a press of the button for using a “5-yen bag”, the display control unit 204 may display a small screen on which the number of 5-yen bags to be used can be input on screen d021. Then, the reception unit 201 may receive the number of bags to be used. Alternatively, the reception unit 201 may count bags one by one whenever the button for using a “5-yen bag” is pressed.

The case where the button for using a “3-yen bag” is pressed may be similar to the case where the button for using a “5-yen bag” is pressed.

Although not illustrated, the display control unit 204 may display the received number of bags to be used for each bag type. Here, the information received by the reception unit 201 will hereinafter be referred to as bag-selection information. The bag-selection information includes, for example, information on the type of the bag that needs to be paid for (e.g., the product ID) and information on the number of bags to be used.

Although not illustrated, screen d021 may include a “confirm” button or the like. For example, when receiving a press of the “confirm” button, the reception unit 201 transmits bag-selection information and a request for checkout information to the server 21.

Furthermore, although not illustrated, screen d021 may include a “purchase product list” button. When the reception unit 201 receives a press of the “purchase product list” button, the display control unit 204 displays the above-described screen d001 illustrated in FIG. 7.

In a case where a settlement method can be selected, similarly to the example of the confirmation regarding a change in tax rate, the reception unit 201 may transmit the bag-selection information and the request for checkout information to the server 21 after receiving a selection of a settlement method.

Next, the list generation unit 211 of the server 21 updates the purchase product list based on information on a product (bag) and a purchase quantity included in the bag-selection information. Then, the checkout information generation unit 212 generates checkout information based on the purchase product list after being updated. The method of generating checkout information by the checkout information generation unit 212 is as described in the example of the confirmation regarding a change in tax rate.

Furthermore, the process after the checkout device 20 receives the checkout information from the server 21 may be similar to that in the example in which a change in tax rate is confirmed. Therefore, the same description will be omitted below.

(Example of Operation for Confirmation Regarding Bag that Needs to be Paid for, Etc.)

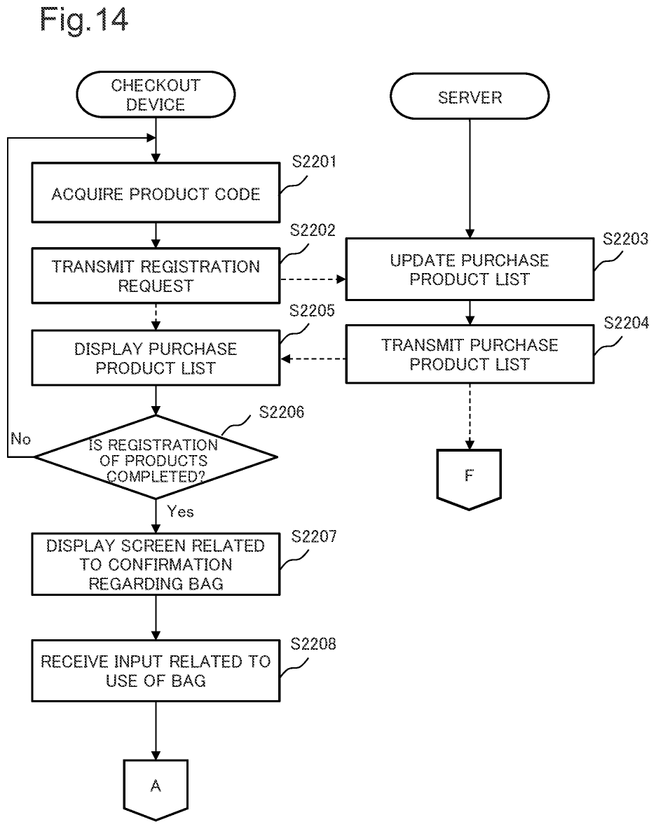

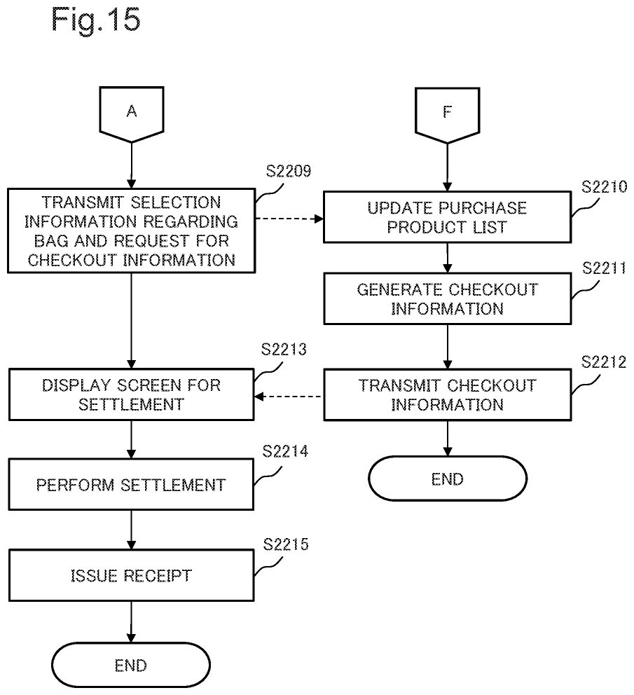

FIGS. 14 and 15 are flowcharts illustrating an example of an operation of the checkout system 2 for a confirmation regarding a bag or the like that needs to be paid for according to the second example embodiment. The acquisition unit 203 acquires a product code from a product through an operation of the customer (step S2201). Then, the acquisition unit 203 transmits a registration request including the product code (step S2202). The list generation unit 211 updates the purchase product list based on the new registration request (step S2203). The list generation unit 211 transmits the purchase product list (step S2204).

The display control unit 204 displays the purchase product list (step S2205). The reception unit 201 determines whether registration of products is completed (step S2206). In step S2206, the reception unit 201 may determine whether registration of products is completed depending on whether the “payment” button has been pressed through an operation of the customer. When registration of products is not completed (step S2206: No), the checkout system 2 returns to step S2101.

When registration of products is completed (step S2206: Yes), the display control unit 204 displays a screen related to a confirmation regarding a bag (step S2207). The reception unit 201 receives an input related to a use of a bag (step S2208). In step S2208, the reception unit 201 may receive an input of the number of bags to be used for each bag type. Furthermore, in step S2208, the reception unit 201 may receive an input of whether to use a bag. As illustrated in screen d021 of FIG. 13, there may be a “no use” button. As described above, the information received in step S2208 is bag-selection information.

The reception unit 201 transmits the received bag-selection information and a request for checkout information to the server 21 (step S2209). The list generation unit 211 updates the purchase product list based on the selection information (step S2210). Then, the checkout information generation unit 212 generates checkout information based on the purchase product list after being updated (step S2211). The checkout information generation unit 212 transmits the generated checkout information (step S2212). Next, the display control unit 204 displays a screen for settlement based on the checkout information (step S2213).

The settlement unit 202 performs a settlement (step S2214). Next, the issuance control unit 205 issues a receipt (step S2215). When the settlement is performed, the checkout device 20 may notify the server 21 that the settlement has been completed. Furthermore, the sales management unit 213 may update the sales DB 2103 based on the settlement.

### [Confirmation Performed by Store Clerk]

Next, an example in which the predetermined confirmation is a confirmation performed by the store clerk will be described. The confirmation performed by the store clerk includes a confirmation as to whether a registration-canceled product has been collected, a confirmation regarding age at the time when an age confirmation product is purchased, or the like.

### (Confirmation Regarding Collection of Canceled Product)

First, a confirmation as to whether a registration-canceled product has been collected will be described. The customer may cancel a registered product. In such a case, the customer may intentionally or accidentally take the canceled product out of the store. The intentional taking out is, for example, a crime such as shoplifting. Therefore, the store clerk wants to reliably collect the canceled product in order to prevent a crime. However, it takes time and effort for the store clerk to go to the checkout device 20 and collect a product whenever the product is canceled. Therefore, in the second example embodiment, after product registration and before settlement, it is confirmed that the store clerk has collected the canceled product.

First, cancellation of a product on screen d001 illustrated in FIG. 7 will be described. As described above, screen d001 includes a “cancel” button for each product type. When receiving a press of the “cancel” button, the reception unit 201 transmits a request for canceling the information on the canceled product to the server 21. In addition, in a case where the purchase quantity is two or more, when the “cancel” button is pressed, the display control unit 204 may display a screen on which the quantity of the product to be canceled can be input in such a manner as to be superimposed on screen d001. Then, the reception unit 201 may receive the quantity of the product to be canceled. The quantity of the product to be canceled is also referred to as a cancellation quantity. When receiving the cancellation quantity, the reception unit 201 transmits cancellation information including information on the product and the cancellation quantity to the server 21.

The list generation unit 211 updates the purchase product list based on the cancellation information. For example, in a case where the purchase quantity and the cancellation quantity are the same, the list generation unit 211 deletes the information on the product to be canceled from the purchase product list. On the other hand, in a case where the purchase quantity is larger than the cancellation quantity, the list generation unit 211 sets the purchase quantity associated with the information on the product in the purchase product list to a quantity obtained by subtracting the cancellation quantity from the purchase quantity.

Here, the cancellation information may be stored in the storage unit 214 of the server 21 or may be stored in the storage unit 208 of the checkout device 20.

The notification unit 206 notifies that the product has been canceled. The notification method is not particularly limited. Specifically, the notification unit 206 notifies the attendant terminal device 22 that the product has been canceled. More specifically, the notification unit 206 may notify the attendant terminal device 22 of the information on the canceled product (e.g., the product ID or the product name) and the cancellation quantity. At this time, the notification unit 206 may notify the information on the canceled product and the cancellation quantity together with an identifier for identifying the checkout device 20. In addition, the notification unit 206 may notify the store clerk by turning on a lamp. Alternatively, notification unit 206 may notify the store clerk by sounding a buzzer or the like. The lamp or the buzzer may be provided in the checkout device 20, or may be provided in a device different from the checkout device 20. In a case where the lamp or the buzzer is provided in a device different from the checkout device 20, the notification unit 206 notifies the different device that the product has been canceled. Then, the different device that has received the notification from the notification unit 206 notifies the store clerk that the product has been canceled by controlling the lamp or the buzzer. In a case where the lamp of the checkout device 20 is turned on or in a case where the buzzer of the checkout device 20 is sounded, the notification unit 206 notifies the store clerk in such a way that the store clerk can distinguish a notification indicating that the product has been canceled from a notification indicating that the “call store clerk” button has been pressed. Furthermore, in a case where the lamp or the buzzer is provided in a device different from the checkout device 20, the different device that has received a notification from the notification unit 206 notifies the store clerk in such a way that the store clerk can distinguish a notification indicating that the product has been canceled from a notification indicating that the “call store clerk” button has been pressed.

When receiving the notification indicating that the product has been canceled, the display control unit 221 displays, on the display device of the attendant terminal device 22, a screen indicating that it is necessary to collect the canceled product. For example, the display control unit 221 of the attendant terminal device 22 may display information (e.g., a product name) on a canceled product and a cancellation quantity for each checkout device 20.

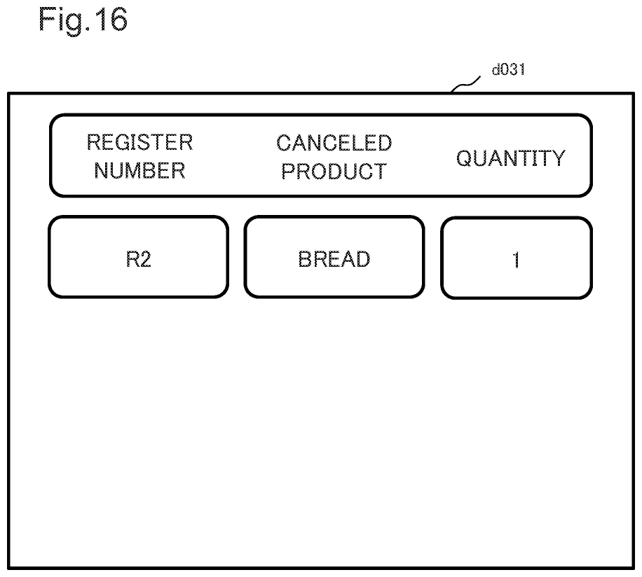

FIG. 16 is an example of a screen showing a product-canceled status for each checkout device 20 displayed on the attendant terminal device 22. Screen d031 includes information on a register number, a product name of the canceled product, and a quantity of the canceled product. In FIG. 16, the register number is an example of an identifier indicating the checkout device 20. According to screen d031, it can be seen that one piece of bread is canceled at the register number R2. By doing so, the store clerk can grasp which checkout device 20 the canceled product is to be collected from by checking the screen d031.

Further, screen d01 is an example, and is not particularly limited. For example, the display control unit 221 may display a screen (not illustrated) in which the canceled product and the quantity of the canceled product are superimposed in the checkout device 20 on the map of the store.

Next, the reception unit 201 receives a press of the “payment” button through an operation of the customer. When the press of the “payment” button is received, in a case where there is a product that has been canceled, the notification unit 206 notifies that it is necessary to collect the product that has been canceled. Hereinafter, the product that has been canceled may be abbreviated as a canceled product. By doing so, the store clerk is called to collect the product. The notification method is not particularly limited. Specifically, the notification unit 206 may notify the attendant terminal device 22 to call the store clerk. Furthermore, the notification unit 206 may give a notification for calling the store clerk by turning on a lamp. Alternatively, the notification unit 206 may give a notification for calling the store clerk by sounding a buzzer or the like. The lamp or the buzzer may be provided in the checkout device 20, or may be provided in a device different from the checkout device 20. In a case where the lamp or the buzzer is provided in a device different from the checkout device 20, the notification unit 206 notifies the different device that the product has been canceled. Then, the different device that has received the notification from the notification unit 206 notifies the store clerk that the product has been canceled by controlling the lamp or the buzzer. In a case where the lamp of the checkout device 20 is turned on or in a case where the buzzer of the checkout device 20 is sounded, the notification unit 206 notifies the store clerk in such a way that the store clerk can distinguish a notification indicating that the product has been canceled from a notification indicating that the “payment” button has been pressed to call the store clerk and a notification indicating that the “call store clerk” button has been pressed to call the store clerk. For example, in a case where the lamp is turned on, the notification unit 206 may give two types of notifications in different lighting colors. Furthermore, in a case where the lamp or the buzzer is provided in a device different from the checkout device 20, the different device that has received a notification from the notification unit 206 notifies the store clerk in such a way that the store clerk can distinguish a notification indicating that the product has been canceled from a notification indicating that the “payment” button has been pressed to call the store clerk and a notification indicating that the “call store clerk” button has been pressed to call the store clerk.

Upon the notification for calling the store clerk is received, the display control unit 221 displays, on the display device of the attendant terminal device 22, a screen indicating that it is necessary to immediately collect the canceled product. Although not illustrated, the screen may include an identifier for identifying the checkout device 20, product information such as a product name of the canceled product, and information on a quantity of the canceled product. The screen may include a message for directing the store clerk to the checkout device 20. In addition, the display control unit 221 may display a screen in which a product name of a canceled product and a message for directing the store clerk to a checkout device 20 are superimposed in the checkout device 20 on the map of the store.

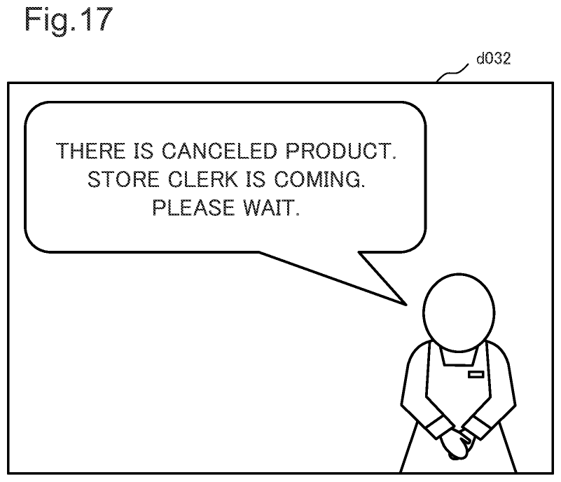

In addition, when the reception unit 201 receives a press of the “payment” button, in a case where there is a canceled product, the display control unit 204 displays a screen for the store clerk to confirm that the canceled product has been confirmed. For example, an example of the screen is illustrated in FIG. 17.

FIG. 17 is an explanatory diagram illustrating an example of a screen indicating that the store clerk is being called in a case where there is a canceled product. When the reception unit 201 receives a press of the “payment” button, in a case where there is a canceled product, the display control unit 204 displays screen d032. Screen d032 includes a message requesting the customer to wait.

Here, in order for the checkout device 20 to proceed to a settlement process from the screen d032, the store clerk completes the collection of the canceled product and makes an input related to a confirmation regarding collection. The input related to the confirmation may be received by the checkout device 20, or may be received by the attendant terminal device 22. An example in which the input related to the confirmation is received by the attendant terminal device 22 will be described in a modification.

First, an example in which the input related to the confirmation is received by the checkout device 20 will be described. The store clerk goes to the checkout device 20 and collects the product. Then, the reception unit 201 of the checkout device 20 receives an input related to a confirmation that the product has been collected through an operation of the store clerk. The method of receiving an input related to a confirmation can be variously changed. More specifically, for example, the reception unit 201 receives an input of a predetermined code through an operation of the store clerk. The predetermined code is not particularly limited. The predetermined code is referred to as a confirmation code. The confirmation code may be a common code. In a case where it is desired to record which store clerk performs the confirmation, the confirmation code may be an identifier (e.g., a store clerk ID) for identifying the store clerk. In a case where a store clerk ID or the like is used, a store clerk DB or the like is stored in the storage unit 214. The input method is not particularly limited. The reception unit 201 may receive the confirmation code by reading a code such as a barcode in which the confirmation code is encoded through the reading device and decoding the code. In addition, the reception unit 201 may acquire the confirmation code from an integrated circuit (IC) card using short-range wireless communication through an operation of the store clerk. In addition, the reception unit 201 may receive an input of the confirmation code via the input device such as a keyboard through an operation of the store clerk.

In addition, the display control unit 204 may display a screen for receiving a confirmation code as a screen for the store clerk to confirm that the canceled product has been collected. If a screen for receiving a confirmation code is displayed immediately after the “payment” button is touched, the customer can perform an operation. Therefore, in order to allow the store clerk to perform an operation while the customer is not allowed to perform an operation, the reception unit 201 may receive an input of a release code for displaying a screen for receiving a confirmation code before the confirmation code is received. Then, when the release code is input, the display control unit 204 displays a screen for receiving a confirmation code. The release code may be the same as or different from the confirmation code.

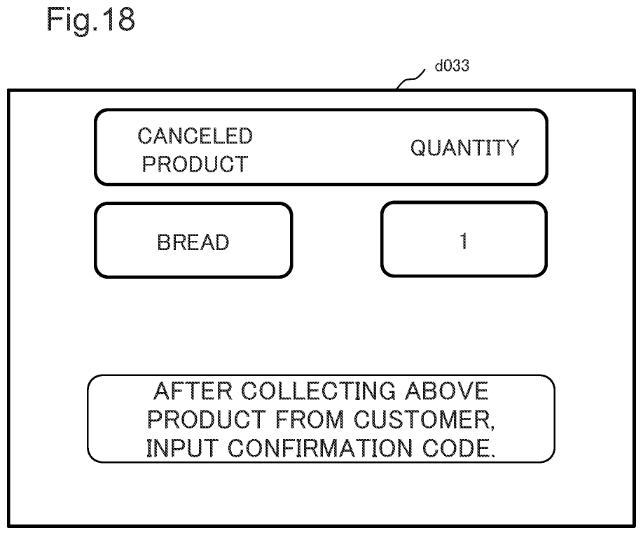

FIG. 18 is an explanatory diagram illustrating an example of a screen for receiving an input of a confirmation code. Screen d033 includes information on a canceled product and a quantity of the canceled product. In addition, screen d033 includes a message prompting the store clerk to input a code. Then, the reception unit 201 may further receive an input of a code for confirmation. The confirmation code inputting method is as described above.

In addition, after the cancellation code is input, the display control unit 204 may display a screen including a “confirm” button that is capable of confirming that the canceled product has been collected, instead of inputting the confirmation code. In this case, similarly to screen d033, a screen that is not illustrated may include information on a canceled product and a quantity of the canceled product. By pressing the “confirm” button through an operation of the store clerk, the reception unit 201 receives an input indicating that the canceled product has been collected.

In a case where a settlement method can be selected, the reception unit 201 may transmit a request for checkout information to the server 21 after receiving a selection of a settlement method, similarly to the example of the confirmation performed by the customer.

Next, the list generation unit 211 of the server 21 generates checkout information based on the purchase product list. The method of generating checkout information by the checkout information generation unit 212 is as described in the example of the confirmation performed by the customer.

Furthermore, the process after the checkout device 20 receives the checkout information from the server 21 may be similar to that in the example of the confirmation performed by the customer. Therefore, the same description will be omitted below.

### (Example of Operation Related to Confirmation Regarding Collection of Canceled Product)

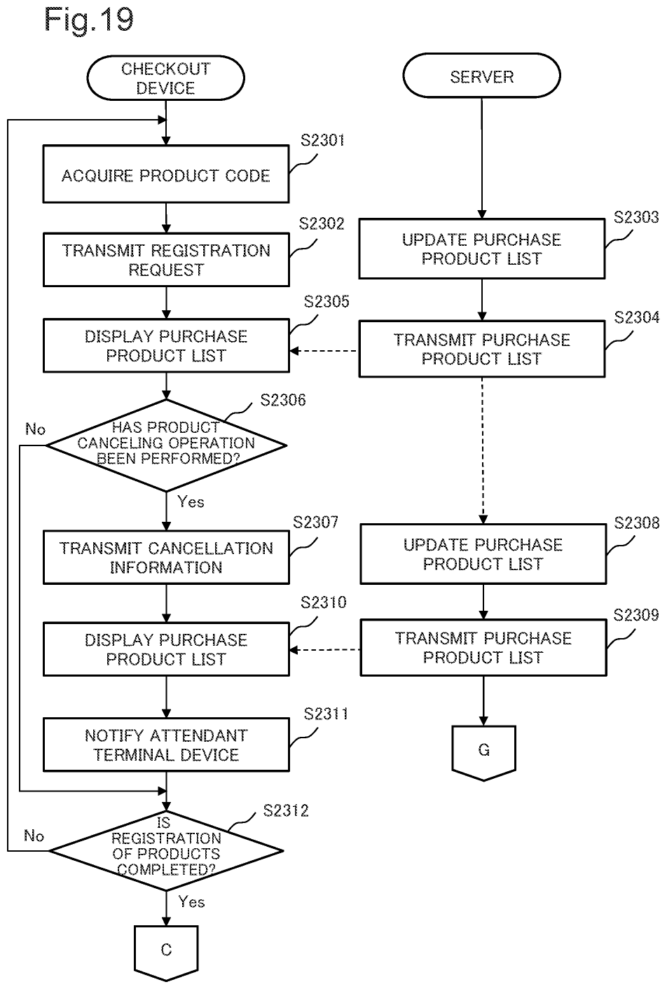

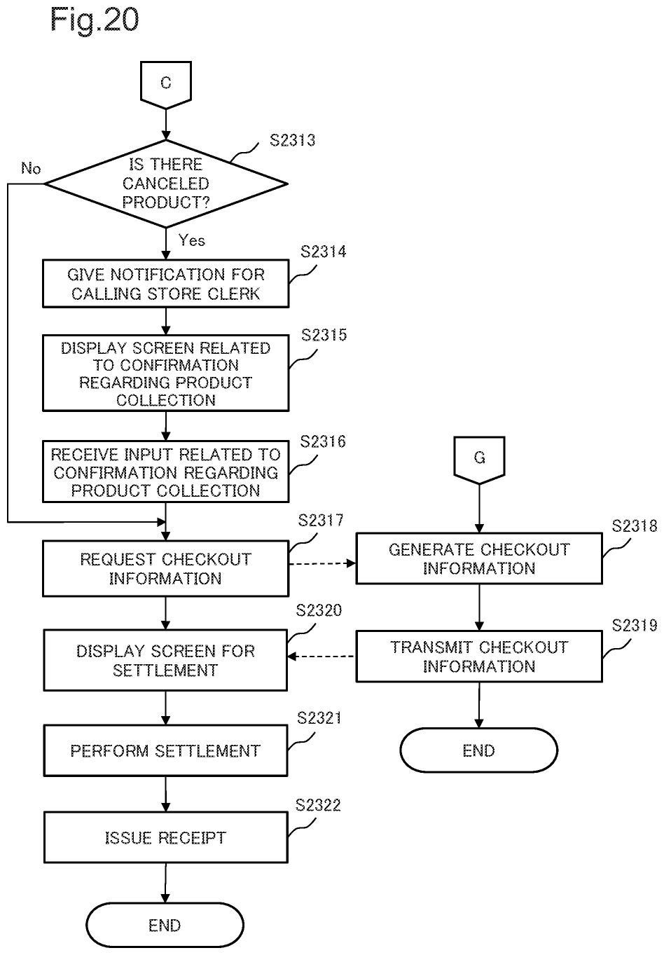

FIGS. 19 and 20 are flowcharts illustrating an example of an operation of the checkout system 2 for a confirmation regarding collection of a canceled product according to the second example embodiment. The acquisition unit 203 acquires a product code from a product through an operation of the customer (step S2301). Then, the acquisition unit 203 transmits a registration request including the product code (step S2302). The list generation unit 211 updates the purchase product list based on the new registration request (step S2303). The list generation unit 211 transmits the purchase product list after being updated (step S2304).

The display control unit 204 displays the purchase product list after being updated (step S2305). Next, the reception unit 201 determines whether a product canceling operation has been performed (step S2306). In step S2306, for example, the reception unit 201 determines whether a product canceling operation has been performed depending on whether a “cancel” button for canceling a product has been operated. When the “cancel” button for canceling a product is pressed, the reception unit 201 may determine that a product canceling operation has been performed. The reception unit 201 may receive a cancellation quantity. When it is determined that a product canceling operation has not been performed (step S2306: No), the checkout device 20 proceeds to step S2312. On the other hand, when it is determined that a product canceling operation has been performed (step S2306: Yes), the reception unit 201 transmits product cancellation information (step S2307). The cancellation information includes, for example, information on a product to be canceled (e.g., a product ID) and a cancellation quantity.

The list generation unit 211 updates the purchase product list based on the cancellation information (step S2308). Next, the list generation unit 211 transmits the purchase product list (step S2309). Next, the display control unit 204 displays the purchase product list after being updated (step S2310).

Then, the notification unit 206 notifies the attendant terminal device 22 that there is a canceled product (step S2311). In step S2311, the notification unit 206 may transmit information in which an identifier for identifying the checkout device 20 is associated with the cancellation information to the attendant terminal device 22. Then, for example, the display control unit 221 of the attendant terminal device 22 displays that the product canceling operation has been performed on the checkout device 20 represented by the identifier. By doing so, the store clerk can easily grasp that the product needs to be collected at the checkout device 20 from which the notification comes by checking the screen of the attendant terminal device 22. Step S2311 may be performed after step S2307 and before step S2310. Alternatively, step S2311 may be performed after Yes in step S2306 and before step S2307.

Next, the reception unit 201 determines whether registration of products is completed (step S2312). In step S2312, the reception unit 201 may determine whether registration of products is completed depending on whether the “payment” button has been pressed through an operation of the customer. When registration of products is not completed (step S2312: No), the checkout system 2 returns to step S2101.

When registration of products is completed (step S2312: Yes), the notification unit 206 determines whether there is a canceled product (step S2313). When there is no canceled product (step S2313: No), the checkout device 20 proceeds to step S2317.

On the other hand, when there is a canceled product (step S2313: Yes), the notification unit 206 gives a notification for calling the store clerk (step S2314). As described above, the notification method is not particularly limited. In step S2314, for example, the notification unit 206 notifies the attendant terminal device 22 that the store clerk is required to collect the product. For example, the display control unit 221 of the attendant terminal device 22 displays, on the display device of the attendant terminal device 22, a screen indicating that the store clerk is required to immediately collect the canceled product at the checkout device 20 from which the notification comes. More specifically, for example, the display control unit 221 may display a screen including information on an identifier of the checkout device 20 from which the notification comes and a name of the product to be collected by the store clerk. For example, the display control unit 221 may display a screen including a name of the product to be collected by the store clerk and a message for directing the store clerk to the checkout device 20. In step S2314, the notification unit 206 may turn on the lamp of the checkout device 20. Alternatively, in step S2314, the notification unit 206 may sound the buzzer of the checkout device 20. The notification method may be a combination thereof. The display control unit 204 displays a screen related to a confirmation regarding product collection (step S2315). The reception unit 201 receives an input related to the confirmation regarding product collection through an operation of the store clerk (step S2316).

The reception unit 201 requests checkout information (step S2317). Next, the checkout information generation unit 212 generates checkout information based on the purchase product list (step S2318). The checkout information generation unit 212 transmits the generated checkout information (step S2319). Next, the display control unit 204 displays a screen for settlement based on the checkout information (step S2320).

The settlement unit 202 performs a settlement (step S2321). Next, the issuance control unit 205 issues a receipt (step S2322). When the settlement is performed, the checkout device 20 may notify the server 21 that the settlement has been completed. Furthermore, the sales management unit 213 may update the sales DB 2103 based on the settlement.

### (Confirmation Regarding Age)

Next, a confirmation regarding an age will be described. The store may be penalized if the store neglects to confirm an age of a customer at the time of selling a product for which it is required to confirm the age of the customer. Therefore, when the customer purchases an age confirmation product, the store clerk needs to perform an age confirmation. However, it takes time and effort for the store clerk to go to the checkout device 20 and confirm an age whenever an age confirmation product is registered. Therefore, in the second example embodiment, an age of a customer is confirmed by the store clerk after product registration and before settlement.

The acquisition unit 203 acquires a product code from a product. Then, the acquisition unit 203 transmits a registration request including the product code.

The list generation unit 211 of the server 21 updates the purchase product list based on the registration request. When updating or generating the purchase product list, the list generation unit 211 transmits the purchase product list or information for identifying the purchase product list to the checkout device 20.

In a case where the newly registered product is an age confirmation product, the notification unit 206 notifies that the age confirmation product has been registered. Specifically, for example, the notification unit 206 may notify the attendant terminal device 22 that the age confirmation product has been registered. More specifically, the notification unit 206 may notify the attendant terminal device 22 of information on the age confirmation product (e.g., a name of the product). At this time, the notification unit 206 may notify an identifier for identifying the checkout device 20 together with the information on the age confirmation product. In addition, the notification unit 206 may notify the store clerk that the age confirmation product has been registered by turning on a lamp. Alternatively, the notification unit 206 may notify the store clerk that the age confirmation product has been registered by sounding a buzzer or the like. The lamp or the buzzer may be provided in the checkout device 20, or may be provided in a device different from the checkout device 20. In a case where the lamp or the buzzer is provided in a device different from the checkout device 20, the notification unit 206 notifies the different device that the product has been canceled. Then, the different device that has received the notification from the notification unit 206 notifies the store clerk that the age confirmation product has been registered by controlling the lamp or the buzzer.

In a case where the lamp of the checkout device 20 is turned on or in a case where the buzzer of the checkout device 20 is sounded, the notification unit 206 notifies the store clerk in such a way that the store clerk can distinguish a notification indicating that the age confirmation product has been registered from a notification indicating that the “call store clerk” button has been pressed to call the store clerk. Furthermore, in a case where the lamp or the buzzer is provided in a device different from the checkout device 20, the different device that has received a notification from the notification unit 206 notifies the store clerk in such a way that the store clerk can distinguish a notification indicating that the age confirmation product has been registered from a notification indicating that the “call store clerk” button has been pressed.

When receiving the notification indicating that the age confirmation product has been registered, the display control unit 221 displays a screen indicating that it is necessary to confirm an age. The display control unit 221 of the attendant terminal device 22 displays information (e.g., a product name) on an age confirmation product for each checkout device 20.

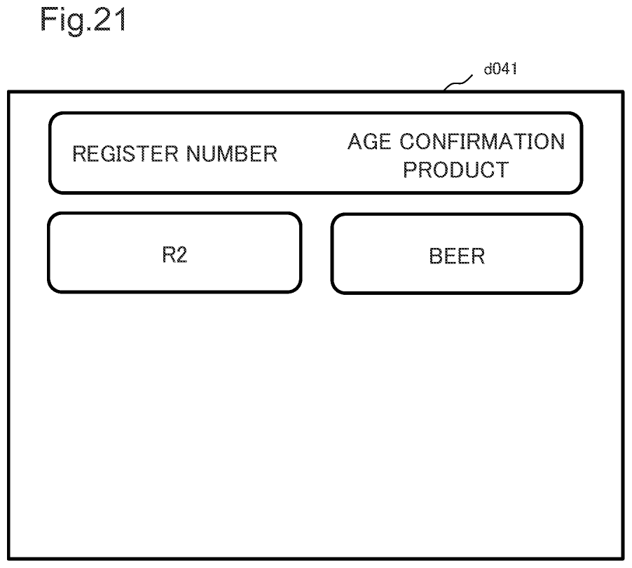

FIG. 21 is an explanatory diagram illustrating an example of a screen related to an age confirmation on the attendant terminal device 22. Screen d041 includes information indicating a name of an age confirmation product for each checkout device 20 in which the age confirmation product is registered. As described above, the register number is an example of an identifier indicating the checkout device 20.

Screen d041 may include information on whether there is an age confirmation product for each checkout device 20. That is, a register number of the checkout device 20 and whether there is an age confirmation product may be displayed on screen d041.

In addition, the display control unit 204 displays the product information registered in the purchase product list on the display device of the checkout device 20. Here, the checkout device 20 may store the fact that the age confirmation product has been registered in the storage unit 208.

Next, the reception unit 201 receives a press of the “settlement” button. When the press of the “settlement” button is received, in a case where an age confirmation product is registered, the notification unit 206 gives a notification for calling the store clerk. For example, the notification unit 206 may notify the attendant terminal device 22 that the store clerk needs to confirm an age. Alternatively, the notification unit 206 may give a notification for calling the store clerk by turning on a lamp. Alternatively, the notification unit 206 may give a notification for calling the store clerk by sounding a buzzer or the like. The lamp or the buzzer may be provided in the checkout device 20, or may be provided in a device different from the checkout device 20. In a case where the lamp or the buzzer is provided in a device different from the checkout device 20, the notification unit 206 notifies the different device that an age confirmation is necessary. Then, the different device that has received the notification from the notification unit 206 may give a notification for the checkout device 20 to call the store clerk by controlling a lamp or a buzzer.

In a case where the lamp of the checkout device 20 is turned on or in a case where the buzzer of the checkout device 20 is sounded, the notification unit 206 notifies the store clerk in such a way that the store clerk can distinguish a notification indicating that the age confirmation product has been registered from a notification indicating that the “payment” button has been pressed to call the store clerk and a notification indicating that the “call store clerk” button has been pressed to call the store clerk. For example, in a case where the lamp is turned on, the notification unit 206 may give three types of notifications in different lighting colors. Furthermore, in a case where the lamp or the buzzer is provided in a device different from the checkout device 20, the different device that has received a notification from the notification unit 206 notifies the store clerk in such a way that the store clerk can distinguish a notification indicating that the age confirmation product has been registered from a notification indicating that the “payment” button has been pressed to call the store clerk and a notification indicating that the “call store clerk” button has been pressed to call the store clerk.

When receiving the notification indicating that the “payment” button has been pressed to call the store clerk, the display control unit 221 of the attendant terminal device 22 displays, on the display device of the attendant terminal device 22, a screen indicating that an age confirmation is to be performed. Although not illustrated, the screen may include information such as an identifier for identifying the checkout device 20 and a product name of the age confirmation product. Furthermore, the screen may include a message for directing the store clerk to the checkout device 20. In addition, the display control unit 221 may display a screen in which a product name of an age confirmation product and a message for directing the store clerk to a checkout device 20 are superimposed in the checkout device 20 on the map of the store.

When a press of the “settlement” button is received, in a case where an age confirmation product is registered, the display control unit 204 displays a screen related to an age confirmation on the display device of the checkout device 20. The screen may be a screen indicating that the store clerk is being called. Alternatively, the screen may be a screen for receiving an input related to an age confirmation performed by the store clerk.

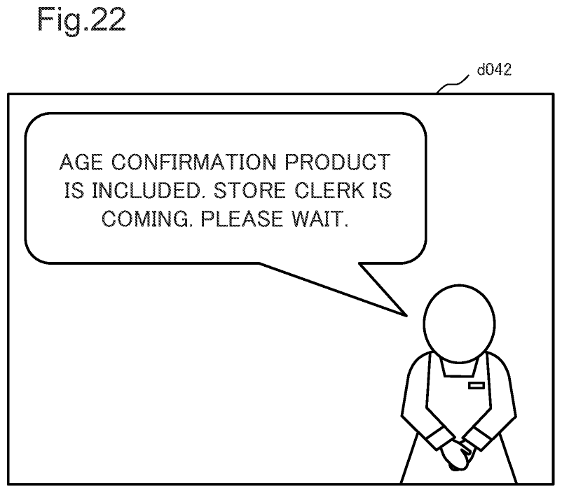

FIG. 22 is an explanatory diagram illustrating an example of a screen indicating that the store clerk is being called in a case where an age confirmation product is registered. When a press of the “payment” button is received, the display control unit 204 displays screen d042 in a case where there is an age confirmation product. Screen d042 includes a message requesting the customer to wait.

Here, for example, in order for the checkout device 20 to proceed from screen d042 to a settlement process, the store clerk confirms an age of the customer. Thereafter, the store clerk performs an input related to the age confirmation. The input related to the confirmation may be received by the checkout device 20, or may be received by the attendant terminal device 22. An example in which the input related to the confirmation is received by the attendant terminal device 22 will be described in a modification.

An example in which the input related to the confirmation is received by the checkout device 20 will be described. The store clerk goes to the checkout device 20 and confirms an age of a customer. Then, the reception unit 201 of the checkout device 20 receives an input related to the confirmation regarding the age through an operation of the store clerk. The method of receiving an input related to a confirmation can be variously changed. The receiving method may be the same as the method of receiving an input related to a confirmation regarding product collection.

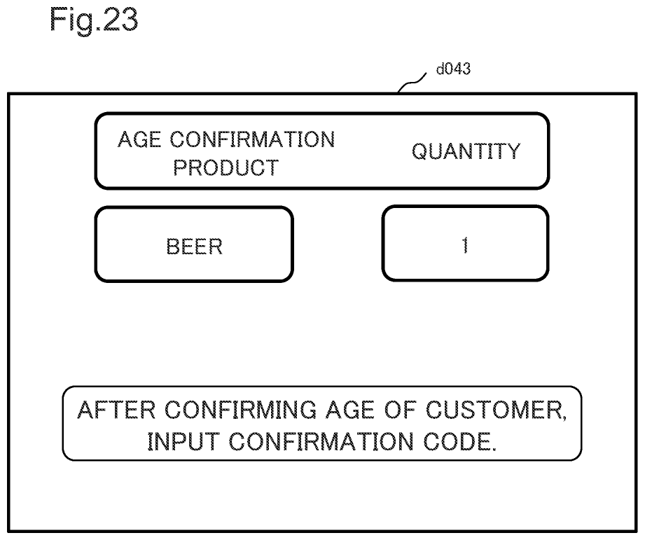

FIG. 23 is an explanatory diagram illustrating an example of a screen for receiving an input of a confirmation code. Screen d043 includes information on an age confirmation product and a purchase quantity. In addition, screen d043 includes a message prompting the store clerk to input a confirmation code. Then, the reception unit 201 may further receive an input of a confirmation code. The confirmation code inputting method is as described above.

In addition, after the cancellation code is input, the display control unit 204 may display a screen including a “confirm” button, instead of inputting the confirmation code. In this case, similarly to screen d043, a screen that is not illustrated may include information on an age confirmation product and a purchase quantity. By pressing the “confirm” button through an operation of the store clerk, the reception unit 201 receives an input indicating that the age has been confirmed.

In a case where a settlement method can be selected, the reception unit 201 may transmit a request for checkout information to the server 21 after receiving a selection of a settlement method, similarly to the example of the confirmation performed by the customer.

Next, the list generation unit 211 of the server 21 generates checkout information based on the purchase product list. The method of generating checkout information by the checkout information generation unit 212 is as described in the example of the confirmation performed by the customer.

Furthermore, the process after the checkout device 20 receives the checkout information from the server 21 may be similar to that in the example of the confirmation performed by the customer. Therefore, the same description will be omitted below.

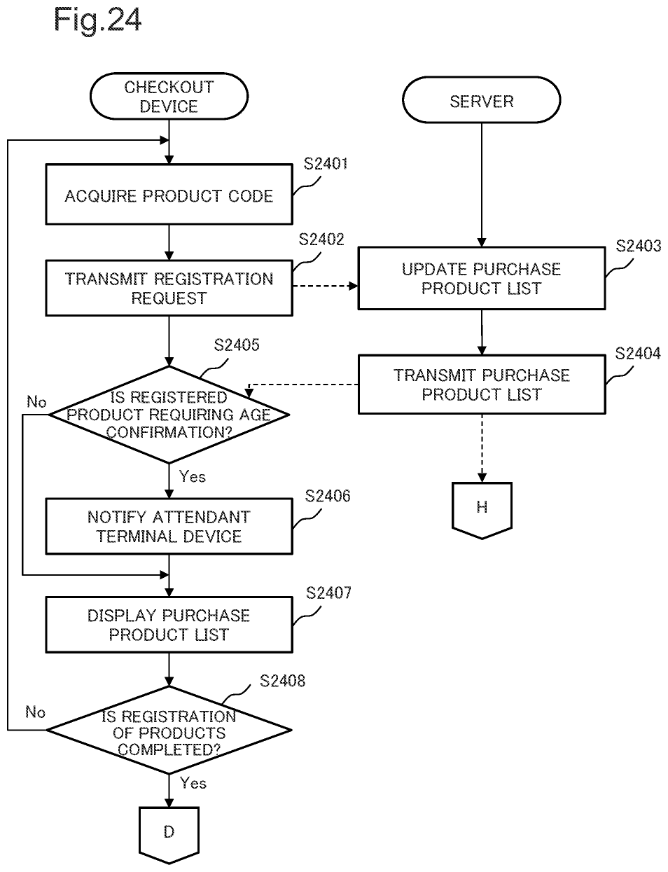

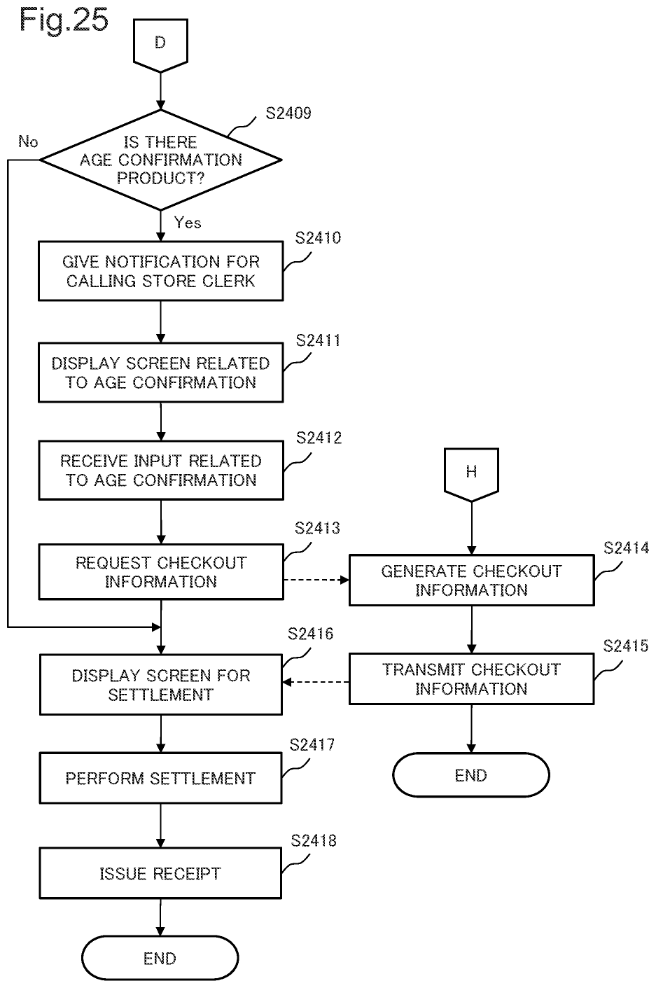

FIGS. 24 and 25 are flowcharts illustrating an example of an operation of the checkout system 2 for a confirmation regarding an age according to the second example embodiment. The acquisition unit 203 acquires a product code from a product through an operation of the customer (step S2401). Then, the acquisition unit 203 transmits a registration request including the product code (step S2402). The list generation unit 211 updates the purchase product list based on the new registration request (step S2403). The list generation unit 211 transmits the purchase product list after being updated (step S2404).

The notification unit 206 determines whether the registered product is an age confirmation product (step S2405). When the registered product is not an age confirmation product (step S2405: No), the display control unit 204 proceeds to step S2407. When the registered product is an age confirmation product (step S2405: Yes), the notification unit 206 notifies the attendant terminal device 22 that the age confirmation product has been registered (step S2406). Then, for example, the display control unit 221 of the attendant terminal device 22 displays that the age confirmation product has been registered in the checkout device 20. By doing so, the store clerk can easily grasp that it is required to confirm an age of the customer at the checkout device 20 from which the notification comes by checking the screen of the attendant terminal device 22.

The display control unit 204 displays the purchase product list (step S2407). The reception unit 201 determines whether registration of products is completed (step S2408). The reception unit 201 may determine whether registration of products is completed depending on whether the “payment” button has been pressed. When registration of products is not completed (step S2408: No), the checkout system 2 returns to step S101. When registration of products is completed (step S2408: Yes), the notification unit 206 determines whether there is an age confirmation product (step S2409). The notification unit 206 gives a notification for calling the store clerk (step S2410). As described above, the notification method is not particularly limited. In step S2410, for example, the notification unit 206 notifies the attendant terminal device 22 that the store clerk is required to confirm an age at the checkout device 20. For example, the display control unit 221 of the attendant terminal device 22 displays, on the display device of the attendant terminal device 22, a screen indicating that the store clerk is required to immediately confirm an age at the checkout device 20 from which the notification comes. More specifically, for example, the display control unit 221 may display a screen including an identifier of the checkout device 20 from which the notification comes and a message for directing the store clerk to the checkout device 20 to confirm an age. In step S2410, the notification unit 206 may turn on the lamp of the checkout device 20. In step S2410, the notification unit 206 may sound the buzzer of the checkout device 20. The notification method may be a combination thereof.

The display control unit 204 displays a screen related to an age confirmation (step S2411). The reception unit receives an input related to the age confirmation through an operation of the store clerk (step S2412). The reception unit 201 requests checkout information (step S2413). Next, the checkout information generation unit 212 generates checkout information based on the purchase product list (step S2414). The checkout information generation unit 212 transmits the generated checkout information (step S2415). Next, the display control unit 204 displays a screen for settlement based on the checkout information (step S2416).

The settlement unit 202 performs a settlement (step S2417). Next, the issuance control unit 205 issues a receipt (step S2418). When the settlement is performed, the checkout device 20 may notify the server 21 that the settlement has been completed. Furthermore, the sales management unit 213 may update the sales DB 2103 based on the settlement.

### (Plurality of Types of Confirmations)

As described above, the predetermined confirmation includes a plurality of types of confirmations. In the second example embodiment, a plurality of different confirmations may be performed after product registration and before settlement.

Here, a combination of a plurality of different confirmations is not particularly limited. For example, the checkout device 20 may require the customer described above to perform two confirmations. Alternatively, for example, the checkout device 20 may require the store clerk described above to perform two confirmations. Alternatively, the checkout device 20 may require the customer to perform one or more confirmations, and require the store clerk to perform one or more confirmations.

The display control unit 204 displays a screen related to each of the plurality of different confirmations. For example, the display control unit 204 may display one screen on which the plurality of different confirmations can be performed. That is, the confirmations may be performed collectively on one screen. The predetermined order, which is an order in which confirmations are performed, is not particularly limited. Then, the reception unit 201 receives inputs corresponding to the plurality of different confirmations.

Furthermore, the display control unit 204 may display screens corresponding to the respective confirmations in a predetermined order. More specifically, the display control unit 204 displays respective screens related to the plurality of different confirmations in the predetermined order. In addition, the reception unit 201 receives inputs corresponding to the plurality of different confirmations in a predetermined order. The predetermined order may be designated by an administrator of the checkout system 2 or the store clerk. Here, after the reception unit 201 receives an input related to a screen that is being displayed, the display control unit 204 may display a screen related to a next confirmation in the predetermined order.

In this way, the plurality of different types of confirmations can be collectively performed before settlement.

Then, the settlement unit 202 performs a settlement after all the inputs related to the plurality of confirmations are received. That is, the settlement unit 202 performs a settlement after the input related to the last confirmation is received in the predetermined order. Here, the settlement method is as described above, and the detailed description of the method will be omitted.

A description will be given using, as an example, a case where four confirmations, including a confirmation regarding a bag or the like that needs to be paid for, a confirmation as to whether to eat or drink a product in a store, a confirmation regarding an age, and a confirmation regarding collection of a canceled product, are performed after product registration and before settlement. In such a case, the confirmations may be performed in descending order of estimated damage to the store. Specifically, the checkout system 2 may perform confirmations, for example, in the order of a confirmation regarding an age, a confirmation regarding collection of a canceled product, a confirmation regarding a bag or the like that needs to be paid for, and a confirmation as to whether to eat or drink a product in a store.

Furthermore, for example, in a case where the plurality of types of confirmations include a confirmation regarding an age and a confirmation regarding collection of a canceled product, the notification unit 206 may give a notification for calling the store clerk to confirm the age and a notification for calling the store clerk to confirm the collection of the canceled product in a distinguishable manner. For example, the notification unit 206 gives, to the attendant terminal device 22, a notification for calling the store clerk to confirm the age and a notification for calling the store clerk to confirm the collection of the canceled product in a distinguishable manner. Then, the display control unit 221 of the attendant terminal device 22 may display, for example, a screen indicating which confirmation the store clerk is being called for. Furthermore, for example, in a case where a lamp is used, the notification unit 206 may set different lighting colors of the lamp to the two notifications. In addition, for example, the notification unit 206 may give a notification for calling the store clerk to confirm the age, a notification for calling the store clerk to confirm the collection of the canceled product, and a notification for calling the store clerk to confirm both the age and the collection of the canceled product in a distinguishable manner. For example, in a case where a lamp is used, the notification unit 206 may set three different lighting colors of the lamp Note that, in a case where a lamp or a buzzer is provided in a device different from the checkout device 20, the different device that has received notifications from the notification unit 206 may perform each of the notifications in a distinguishable manner.

Alternatively, for example, the notification unit 206 may give a notification for calling the store clerk to confirm the age and a notification for calling the store clerk to confirm the collection of the canceled product without distinguishing them from each other. For example, the notification unit 206 notifies the attendant terminal device to simply call the store clerk. Then, the display control unit 221 of the attendant terminal device 22 may display, on the display device of the attendant terminal device 22, for example, a screen indicating that the store clerk is being called at the checkout device 20 from which the notification comes. For example, in a case where a lamp is used, the notification unit 206 performs any notification for calling the store clerk by turning on the lamp in the same color. Note that, in a case where a lamp or a buzzer is provided in a device different from the checkout device 20, the different device that has received notifications from the notification unit 206 may perform each of the notifications without distinguishing them from each other.

An input related to a confirmation regarding an age through an operation of the store clerk and an input related to a confirmation regarding collection of a canceled product through an operation of the store clerk may be performed separately. Alternatively, an input related to a confirmation regarding an age through an operation of the store clerk and an input related to a confirmation regarding collection of a canceled product through an operation of the store clerk may be performed simultaneously. For example, in a case where both a confirmation regarding an age and a confirmation regarding collection of a canceled product are performed, the reception unit 201 may receive an input related to both confirmations by receiving a confirmation code once.

The confirmation code for the confirmation regarding the age and the confirmation code for the confirmation regarding the collection of the canceled product may be the same or different. In addition, both confirmation codes may be codes given for each store clerk. Alternatively, one of the confirmation codes may be a code given for each store clerk, the other one of the confirmation codes may be a code common among store clerks, or both confirmation codes may be codes common among store clerks.

In addition, d032 illustrated in FIG. 17 and d042 illustrated in FIG. 22 may be one common screen. For example, when receiving the above-described release code, the reception unit 201 may sequentially receive inputs related to respective confirmations. For example, when receiving the above-described release code, the reception unit 201 may collectively receive an input related to both confirmations.

As described above, in the second example embodiment, the checkout system 2 receives an input corresponding to a predetermined confirmation after product registration and before settlement. Then, when receiving the input corresponding to the predetermined confirmation, the checkout system 2 performs a settlement. By doing so, the predetermined confirmation can be performed before settlement without trouble.

In addition, the predetermined confirmation may include a plurality of different confirmations. By doing so, the checkout system 2 can collectively perform the confirmations at the end before settlement, and as a result, it is possible to save time and effort of the customer and the store clerk.

In a case where the predetermined confirmation includes a plurality of different confirmations, the checkout system 2 receives respective inputs corresponding to the plurality of different confirmations after product registration and before settlement. Then, the checkout system 2 performs a settlement after all the inputs are received. By doing so, the checkout system 2 can collectively perform the confirmations at the end before settlement, and as a result, it is possible to save time and effort of the customer and the store clerk.

In addition, the checkout system 2 receives the respective inputs corresponding to the plurality of different confirmations in a predetermined order. By doing so, the checkout system 2 can perform the confirmations in the determined order, such as in descending order of estimated damage to the store.

In addition, a case where the predetermined confirmation is a confirmation regarding a bag or the like that needs to be paid for will be described. There is a case where the customer wants to change whether to add a plastic bag that needs to be paid for or the number of plastic bags before product registration or during product registration. The final price varies depending on whether to add a plastic bag that needs to be paid for or the number of plastic bags. Therefore, after product registration and before settlement, the checkout system 2 displays a screen related to a confirmation regarding a plastic bag that needs to be paid for, and receives an input related to a confirmation regarding a plastic bag that needs to be paid for through an operation of the customer. By doing so, after product registration and before settlement, the customer can confirm whether to add a plastic bag or the number of plastic bags without trouble. Note that the same effect can be obtained by performing a confirmation regarding a spoon, a pair of chopsticks, a fork, a container, or the like that needs to be paid for, not limited to the plastic bag that needs to be paid for, in the same manner as the plastic bag that needs to be paid for.

In addition, a confirmation as to whether to eat or drink a product in the store will be described. As described above, when a product is eaten or drunk in a store, the tax rate changes. For this reason, a final price changes depending on whether a product is eaten or drunk in the store, and thus, it is necessary to determine whether to eat or drink a product in the store before settlement. Therefore, after product registration and before settlement, the checkout system 2 displays a screen related to a confirmation as to whether to eat or drink a product in the store, and receives an input related to a confirmation as to whether to eat or drink a product in the store through an operation of the customer. By doing so, after product registration and before settlement, the customer can confirm whether to eat or drink a product in the store.

In addition, the checkout system 2 specifies a product that can be eaten or drunk in the store after product registration and before settlement. Then, the checkout system 2 displays a screen related to a confirmation as to whether to eat or drink a product in the store for the specified product. By doing so, the customer can easily select whether to eat or drink a product in the store.

In addition, a confirmation regarding collection of a canceled product will be described. As described above, the customer may cancel a registered product. In such a case, the customer may intentionally or accidentally take the canceled product out of the store. The store clerk wants to reliably collect the canceled product to prevent a crime. However, it takes time and effort for the store clerk to go to the checkout device 20 and collect a product whenever the product is canceled. Therefore, after product registration and before settlement, the checkout system 2 displays a screen related to a confirmation regarding product collection, and receives an input related to a confirmation regarding product collection through an operation of the store clerk. By doing so, the store clerk can collect canceled products collectively. As a result, the checkout system 2 can save time and effort of the store clerk.

In addition, a confirmation regarding an age will be described. As described above, the customer may register a product that requires an age confirmation, such as alcohol. In such a case, the store clerk needs to confirm an age of the customer who is a purchaser. However, it takes time and effort for the store clerk to go to the checkout device 20 and confirm an age whenever an age confirmation product is registered. Therefore, when an age confirmation product is registered, the checkout system 2 notifies the store clerk that the age confirmation product has been registered. Then, the checkout system 2 receives an input corresponding to the age confirmation through an operation of the store clerk after product registration and before the payment. By doing so, after product registration and before settlement, the store clerk can confirm the age of the customer. As a result, the checkout system 2 can save time and effort of the store clerk.

The second example embodiment is not limited to the examples described above, and various modifications can be made. In addition, each functional unit of the checkout device 20 and the server 21 may be achieved by one device. For example, the checkout system 2 may include the checkout device 20, and the checkout device 20 may include all the illustrated functional units of the checkout device 20 and all the illustrated functional units of the server 21. Alternatively, each functional unit of the checkout device 20 may be achieved by a plurality of devices. Each function of the server 21 may be achieved by a plurality of devices. For example, the server 21 may be one server 21 as illustrated in FIG. 3, or may include a plurality of servers 21. Examples of the plurality of servers 21 include a database server, a backbone server, a point of sales (POS) server, a price look up (PLU) server, and the like.

The checkout system 2 may be configured in such a way that some functional units of the checkout device 20 are included in the server 21. In addition, the checkout system 2 may be configured in such a way that some functional units of the server 21 are included in the checkout device 20. In addition, in each screen, each button is a button of a graphic user interface (GUI), but the type of the button is not particularly limited. Further, in each screen, the position of each button and the position of each display field are not particularly limited. In each screen, buttons, information, display fields, and the like that are not illustrated may be added. Furthermore, the background color of the screen and the like may be changed.

Next, a modification of the second example embodiment will be described.

### First Modification of Second Example Embodiment

In the second example embodiment, the list generation unit 211 of the server 21 updates the purchase product list and transmits the updated purchase product list to the checkout device 20. Then, the display control unit 204 of the checkout device 20 displays the received purchase product list.

In a first modification, the list generation unit 211 of the server 21 may transmit an identifier for identifying the purchase product list to the checkout device 20. Then, the display control unit 204 of the checkout device 20 acquires the purchase product list associated to the identifier for identifying the purchase product list from the purchase product list DB 2102. Then, the display control unit 204 of the checkout device 20 may display the read purchase product list. The first modification is useful when the server 21 is divided into a plurality of different servers such as a database server and a POS server.

### Second Modification of Second Example Embodiment

In the second example embodiment, the checkout information generation unit 212 of the server 21 calculates a total amount (a final price) of tax-inclusive prices, and transmits checkout information including the final price to the checkout device 20. Then, the settlement unit 202 of the checkout device 20 performs a settlement based on the received checkout information.

In a second modification, the checkout information generation unit 212 may store checkout information in the storage unit 214, and transmit an identifier for identifying the checkout information instead of transmitting the checkout information. Then, the settlement unit of the checkout device 20 may acquire checkout information associated to the received identifier from the storage unit 214 of the server 21. Then, the settlement unit 202 of the checkout device 20 performs a settlement based on the acquired checkout information. The modification is useful when the server 21 is divided into a plurality of different servers such as a database server and a POS server.

### Third Modification of Second Example Embodiment

In the second example embodiment, an example in which the checkout information generation unit 212 is included in the server 21 has been described. In this example, the checkout information generation unit 212 of the server 21 calculates a total amount (a final price) of tax-inclusive prices, and transmits checkout information including the final price to the checkout device 20. Then, the checkout device 20 performs a settlement based on the final price calculated by the server 21.

In a third modification, the checkout information generation unit 212 may be included in the checkout device 20. That is, the checkout information generation unit 212 of the checkout device 20 may calculate a total amount (a final price) of tax-inclusive prices including the consumption tax based on the purchase product list.

### Fourth Modification of Second Example Embodiment

Next, in the second example embodiment, an example in which the input related to the confirmation regarding the collection of the canceled product is received by the checkout device 20 has been described. In a fourth modification, an example in which the input related to the confirmation regarding the collection of the canceled product is received by the attendant terminal device 22 will be described. When the “payment” button is pressed on the checkout device 20, the display control unit 204 of the checkout device 20 displays screen d032 illustrated in FIG. 17. Then, when the “payment” button is pressed on the checkout device 20, the display control unit 221 of the attendant terminal device 22 may display screen d033 illustrated in FIG. 18.

For example, when screen d033 illustrated in FIG. 18 is displayed on the attendant terminal device 22, the store clerk goes to the checkout device 20. When collecting the canceled product, the store clerk returns to the attendant terminal device 22. Then, a reception unit (not illustrated) of the attendant terminal device 22 receives an input related to a confirmation that the product has been collected through an operation of the store clerk. The method of receiving an input related to a confirmation can be variously changed similarly to that in a case where an input related to a confirmation is received by the checkout device 20.

In addition, in a case where there are two or more store clerks, when one store clerk goes to take a product and another store clerk confirms that the one store clerk has collected the product, the another store clerk may perform an input related to the confirmation of product collection to the attendant terminal device 22. Since the reception unit (not illustrated) of the attendant terminal device 22 receives the input related to the confirmation regarding the product collection, the possibility that the customer performs an operation can be reduced.

### Fifth Modification of Second Example Embodiment

Next, in the second example embodiment, an example in which the input related to the confirmation regarding the age is received by the checkout device 20 has been described. In a fifth modification, an example in which the input related to the confirmation regarding the age is received by the attendant terminal device 22 will be described. When the “payment” button is pressed on the checkout device 20, the display control unit 204 of the checkout device 20 displays screen d042 illustrated in FIG. 22. Then, when the “payment” button is pressed on the checkout device 20, the display control unit 221 of the attendant terminal device 22 may display screen d043 illustrated in FIG. 23.

For example, when screen d043 illustrated in FIG. 23 is displayed on the attendant terminal device 22, the store clerk goes to the checkout device 20. The store clerk checks an age of the customer. Then, the store clerk returns to the attendant terminal device 22. A reception unit (not illustrated) of the attendant terminal device 22 receives an input indicating that the age of the customer has been confirmed through an operation of the store clerk. The method of receiving an input related to a confirmation can be variously changed similarly to that in a case where an input related to a confirmation is received by the checkout device 20.

Furthermore, in a case where there are two or more store clerks, when one store clerk goes to confirm an age of the customer and another store clerk grasps that the one store clerk has confirmed the age, the another store clerk may perform an input indicating that the age has been confirmed to the attendant terminal device 22. Since the attendant terminal device 22 receives the input related to the confirmation regarding the age, the possibility that the customer performs an operation can be reduced.

### Sixth Modification of Second Example Embodiment

In the second example embodiment, an example in which the notification unit 206 is included in the checkout device 20, and the notification unit 206 performs various kinds of notifications to the store clerk has been described. For example, the notification unit 206 may be included in the server 21. In such a case, the notification unit 206 of the server 21 gives a notification regarding age confirmation and a notification regarding collection of a canceled product. Furthermore, the notification unit 206 of the server 21 may determine whether the registered product is an age confirmation product.

In addition, the checkout device 20 may have some of the functions of the notification unit 206, and the server 21 may have the other functions of the notification unit 206, and various changes can be made.

### Seventh Modification of Second Example Embodiment

In the second example embodiment, an example in which the display control unit 204 is included in the checkout device 20, and the display control unit 204 performs a control to display each screen on the display device of the checkout device has been described. For example, the display control unit 204 may be included in the server 21. In such a case, the display control unit 204 of the server 21 may generate information on a screen to be displayed on the display device of the checkout device or the like, and the checkout device 20 may display the screen on the display device based on the information on the screen.

### Eighth Modification of Second Example Embodiment

In the second example embodiment, an example in which the display control unit 204 displays a screen related to a predetermined confirmation after product registration is completed and before settlement has been described. The checkout device 20 is not limited to the example in which a screen related to a predetermined confirmation is displayed, and may perform an output related to the predetermined confirmation. For example, the checkout device 20 may include an output control unit that is not illustrated. Then, the output control unit may perform an output related to the predetermined confirmation. More specifically, the output control unit may output a voice related to the predetermined confirmation through a speaker.

In addition, the output control unit may control various kinds of outputs instead of displaying other screens, not limited to the screen related to the predetermined confirmation. In addition, both the display of the screen by the display control unit 204 and the output by the output control unit may be performed. Specifically, for example, both the display of the screen by the display control unit 204 and the output of the voice by the output control unit may be performed.

The description of the modifications ends here. In addition, the example embodiments and the modifications thereof may be used in combination.

### (Computer Device)

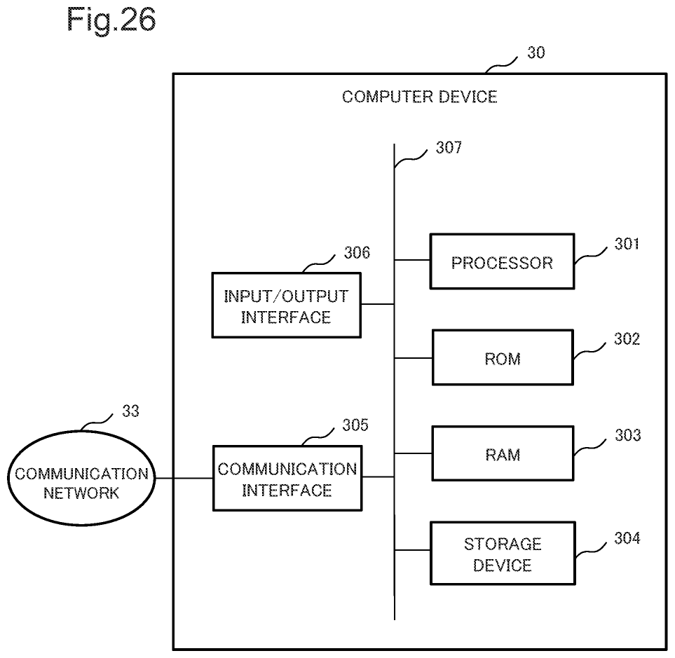

Next, an example of a hardware configuration in a case where each of the devices such as the checkout device 20, the server 21, and the attendant terminal device 22 described in the second example embodiment is achieved by a computer device will be described. FIG. 26 is an explanatory diagram illustrating the example of the hardware configuration of the computer device. For example, some or all of the devices such as the checkout device 20 described in the second example embodiment can be achieved by using, for example, any combination of the computer device 30 as illustrated in FIG. 26 with programs.

The computer device 30 includes, for example, a processor 301, a ROM 302, a RAM 303, a storage device 304, a communication interface 305, and an input/output interface 306. These components are connected to each other via a bus 307.

The processor 301 controls the entire computer device 30. Examples of the processor 301 include a central processing unit (CPU), a digital signal processor (DSP), and the like. The number of processors 301 may be plural. The ROM 302, the RAM 303, the storage device 304, and the like are included in the computer device 30 as storage units. Examples of the storage device 304 include a semiconductor memory such as a flash memory, an HDD, an SSD, and the like. For example, the storage device 304 stores an operating system (OS) program, an application program, a program according to each example embodiment, and the like. Alternatively, the ROM 302 stores an application program, a program according to each example embodiment, and the like. Then, the RAM 303 is used as a work area of the processor 301.

In addition, the processor 301 loads a program stored in the storage device 304, the ROM 302, or the like. Then, the processor 301 executes each process coded in the program. In addition, the processor 301 may download various programs via the communication network 33. In addition, the processor 301 functions as some or all of the computer device 30. Then, the processor 301 may execute a process or an instruction in the illustrated flowchart based on the program.

The communication interface 305 is connected to the communication network 33 such as a local area network (LAN) or a wide area network (WAN) through a wireless or wired communication line. By doing so, the computer device 30 is connected to an external device or an external computer via the communication network 33. The communication interface 305 manages an interface between the communication network 33 and the inside of the computer device 30. Also, the communication interface 305 controls input and output of data from and to an external device or an external computer.

Furthermore, the input/output interface 306 is connected to at least one of an input device, an output device, and an input/output device. The connection method may be wireless or wired. Examples of the input device include a keyboard, a mouse, a microphone, and the like. Examples of the output device include a display device, a lighting device, a speaker that outputs a voice, and the like. Examples of the input/output device include a touch panel display, and the like. The input device, the output device, the input/output device, and the like may be built in the computer device 30 or may be externally attached.

The hardware configuration of the computer device 30 is an example. The computer device 30 may have a configuration including some of the components illustrated in FIG. 26. The computer device 30 may have components other than the components illustrated in FIG. 26. For example, the computer device 30 may include a drive device or the like. Then, the processor 301 may read a program or data from a recording medium mounted on the drive device or the like to the RAM 303. Examples of the recording medium include an optical disk, a flexible disk, a magnetic optical disk, a universal serial bus (USB) memory, and the like. Furthermore, for example, the computer device 30 may include an input device such as a keyboard or a mouse. The computer device 30 may include an output device such as a display. Furthermore, the computer device 30 may include an input device and an output device like a PC.

The computer device 30 may include a reading device such as a barcode reader or a camera capable of reading a barcode or the like. When an RFID is used, the computer device 30 may include an RFID reader. When an IC card is used, the computer device 30 may include a reader for short-range wireless communication.

Furthermore, the computer device 30 may include a camera (not illustrated) capable of capturing an image of a customer, a store clerk, or the like.

The computer device 30 may include various types of sensors that are not illustrated. The types of sensors are not particularly limited. Examples of the sensors include an acceleration sensor, a gyro sensor, a magnetic sensor, a global positioning system (GPS), a sensor, and the like. In addition, examples of the sensors include a fingerprint sensor, a light, detection and ranging (LiDAR), a proximity sensor, and an ambient light sensor.

The description of the hardware configuration of each device ends here. In addition, there are various modifications to the method for achieving each device. For example, the information processing system may be achieved by any combination of a program with a computer different for each component. In addition, a plurality of components included in each of the devices may be achieved by any combination of a program with one computer.

In addition, some or all of the components of the information processing system may be achieved by a circuit for specific use. In addition, some or all of the information processing system may be achieved by a general-purpose circuit including a processor such as a field programmable gate array (FPGA). Furthermore, some or all of the information processing system may be achieved by a combination of a circuit for specific use, a general-purpose circuit, and the like. In addition, these circuits may be single integrated circuits. Alternatively, these circuits may be divided into a plurality of integrated circuits. The plurality of integrated circuits may be connected to each other via a bus or the like.

In addition, in a case where some or all of each component of each device is achieved by a plurality of computers, circuits, or the like, the plurality of computers, circuits, or the like may be arranged in a centralized manner or in a distributed manner.

The method described in each example embodiment is achieved, for example, by execution by a computer such as a checkout device or a server. In addition, the method is achieved by a computer such as the checkout device or the server executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by the computer when read from the recording medium. Furthermore, the program may be distributed via the communication network 33.

The function of each component of the information processing system in each example embodiment may be achieved with hardware as in the computer illustrated in FIG. 26. Alternatively, each component may be achieved by a computer device or firmware based on the control of the program.

While the present disclosure has been particularly shown and described with reference to the example embodiments thereof, the present disclosure is not limited to these example embodiments. It will be understood by those of ordinary skill in the art that various changes in form and details may be applied to the example embodiments without departing from the spirit and scope of the present disclosure as defined by the claims. The present disclosure may include example embodiments in which the matters described in the present specification are appropriately combined or replaced if necessary. For example, the matters described using a specific example embodiment can be applied to another example embodiment as long as no contradiction occurs. For example, although a plurality of operations are described in order in the form of a flowchart, the order in which the operations are described does not limit an order in which the plurality of operations are executed. Therefore, when each example embodiment is carried out, the order in which the plurality of operations are executed can be changed within a range that does not interfere with the content.

Some or all of the above-described example embodiments can also be described as in the following supplementary notes. However, some or all of the above-described example embodiments are not limited to the following supplementary notes.

### (Supplementary Note 1)

An information processing system including:
a reception means configured to receive an input corresponding to a predetermined confirmation after registration of information on products to be purchased by a customer is completed through an operation of the customer and before settlement for the registered products; and
a settlement means configured to perform the settlement for the registered products after the input corresponding to the predetermined confirmation is received.

### (Supplementary Note 2)

The information processing system according to supplementary note 1, in which
the predetermined confirmation is a confirmation that needs to be completed before settlement.

### (Supplementary Note 3)

The information processing system according to supplementary note 1 or 2, in which
the predetermined confirmation includes a plurality of different confirmations.

### (Supplementary Note 4)

The information processing system according to supplementary note 3, in which
the reception means receives respective inputs corresponding to the plurality of confirmations, and
the settlement means performs settlement for the products after all the respective inputs corresponding to the plurality of confirmations are received.

### (Supplementary Note 5)

The information processing system according to supplementary note 4, in which
the reception means receives the respective inputs corresponding to the plurality of confirmations in a predetermined order.

### (Supplementary Note 6)

The information processing system according to supplementary note 5, in which
the plurality of confirmations includes a confirmation performed by the customer and a confirmation performed by a store clerk.

### (Supplementary Note 7)

The information processing system according to supplementary note 6, in which
the reception means receives the confirmation performed by the customer after an input corresponding to the confirmation performed by the store clerk is received, and
the settlement means performs settlement for the products after an input corresponding to the confirmation performed by the customer is received.

### (Supplementary Note 8)

The information processing system according to any one of supplementary notes 1 to 5, in which
the predetermined confirmation is a confirmation performed by the customer.

### (Supplementary Note 9)

The information processing system according to supplementary note 8, in which
the confirmation performed by the customer is a confirmation as to whether the registered products are to be eaten or drunk in a store.

### (Supplementary Note 10)

The information processing system according to supplementary note 9, further including:
a specifying means configured to specify a candidate product that is allowed to be eaten or drunk in the store among the registered products,
in which the reception means receives an input corresponding to a confirmation as to whether the specified candidate product is to be eaten or drunk in the store.

### (Supplementary Note 11)

The information processing system according to supplementary note 8, in which
the confirmation performed by the customer is a confirmation as to whether to use a predetermined product.

### (Supplementary Note 12)

The information processing system according to supplementary note 11, in which
the predetermined product is a bag that needs to be paid for.

### (Supplementary Note 13)

The information processing system according to any one of supplementary notes 1 to 5, in which
the predetermined confirmation is a confirmation performed by a store clerk.

### (Supplementary Note 14)

The information processing system according to supplementary note 13, in which
the confirmation performed by the store clerk is a confirmation indicating that the store clerk has collected a product of which the registration has been canceled through an operation of the customer among the registered products.

### (Supplementary Note 15)

The information processing system according to supplementary note 14, further including:
a notification means configured to notify the store clerk to collect the product of which the registration has been canceled through the operation of the customer among the registered products, after registration of information on the products is completed and before settlement for the registered products.

### (Supplementary Note 16)

The information processing system according to supplementary note 15, in which
the notification means further notifies the store clerk that there is the product of which the registration has been canceled through the operation of the customer when the product is canceled.

### (Supplementary Note 17)

The information processing system according to supplementary note 15 or 16, in which the notification means notifies a terminal device of the store clerk.

### (Supplementary Note 18)

The information processing system according to supplementary note 13, in which
the confirmation performed by the store clerk is an age confirmation when any of the registered products is a product that requires the store clerk to confirm an age of the customer, and
the information processing system further includes a notification means configured to notify the store clerk that the product requiring an age confirmation has been registered when the product requiring an age confirmation has been registered.

### (Supplementary Note 19)

The information processing system according to supplementary note 18, in which
when the product requiring an age confirmation has been registered, the notification means further notifies the store clerk to perform an age confirmation after registration of information on the products is completed and before settlement for the products.

### (Supplementary Note 20)

The information processing system according to supplementary note 18 or 19, in which
the notification means notifies a terminal device of the store clerk.

### (Supplementary Note 21)

A method including:
receiving an input corresponding to a predetermined confirmation after registration of information on products to be purchased by a customer is completed through an operation of the customer and before settlement for the registered products; and
performing settlement for the registered products after the input corresponding to the predetermined confirmation is received.

### (Supplementary Note 22)

A non-transitory computer-readable recording medium recording a program for causing a computer to execute:
receiving an input corresponding to a predetermined confirmation after registration of information on products to be purchased by a customer is completed through an operation of the customer and before settlement for the registered products; and
performing settlement for the registered products after the input corresponding to the predetermined confirmation is received.

### (Supplementary Note 23)

A program for causing a computer to execute:
receiving an input corresponding to a predetermined confirmation after registration of information on products to be purchased by a customer is completed through an operation of the customer and before settlement for the registered products; and
performing settlement for the registered products after the input corresponding to the predetermined confirmation is received.

### REFERENCE SIGNS LIST

1 Information processing system
2 Checkout system
20 Checkout device
21 Server
22 Attendant terminal device
23 Communication network
30 Computer device
33 Communication network
101 Reception unit
102 Settlement unit
201 Reception unit
202 Settlement unit
203 Acquisition unit
204 Display control unit
205 Issuance control unit
206 Notification unit
207 Specifying unit
208 Storage unit
211 List generation unit
212 Checkout information generation unit
213 Sales management unit
214 Storage unit
221 Display control unit
222 Storage unit
301 Processor
302 ROM
303 RAM
304 Storage device
305 Communication interface
306 Input/output interface
307 Bus
d001 Screen
d002 Screen
d011 Screen
d012 Screen
d021 Screen
d031 Screen
d032 Screen
d033 Screen
d041 Screen
d042 Screen
d043 Screen
2101 Product DB
2102 Purchase product list DB
2103 Sales DB

What is claimed is:

1. An information processing system comprising:
at least one memory storing instructions; and
at least one processor configured to execute the instructions to:
to receive an input corresponding to a predetermined confirmation after registration of information on products to be purchased by a customer is completed through an operation of the customer and before settlement for the registered products; and
to perform the settlement for the registered products after the input corresponding to the predetermined confirmation is received.

2. The information processing system according to claim 1, wherein
the predetermined confirmation is a confirmation that needs to be completed before settlement.

3. The information processing system according to claim 1, wherein
the predetermined confirmation includes a plurality of different confirmations.

4. The information processing system according to claim 3, wherein
the at least one processor is further configured to execute the instructions to:
receive respective inputs corresponding to the plurality of confirmations, and
perform settlement for the products after all the respective inputs corresponding to the plurality of confirmations are received.

5. The information processing system according to claim 4, wherein
the at least one processor is further configured to execute the instructions to:
receive the respective inputs corresponding to the plurality of confirmations in a predetermined order.

6. The information processing system according to claim 5, wherein
the plurality of confirmations include a confirmation performed by the customer and a confirmation performed by a store clerk.

7. The information processing system according to claim 6, wherein
the at least one processor is further configured to execute the instructions to:
receive the confirmation performed by the customer after an input corresponding to the confirmation performed by the store clerk is received, and
perform settlement for the products after an input corresponding to the confirmation performed by the customer is received.

8. The information processing system according to claim 1, wherein
the predetermined confirmation is a confirmation performed by the customer.

9. The information processing system according to claim 8, wherein
the confirmation performed by the customer is a confirmation as to whether the registered products are to be eaten or drunk in a store.

10. The information processing system according to claim 9, wherein
the at least one processor is further configured to execute the instructions to:
specify a candidate product that is allowed to be eaten or drunk in the store among the registered products,
receive an input corresponding to a confirmation as to whether the specified candidate product is to be eaten or drunk in the store.

11. The information processing system according to claim 8, wherein
the confirmation performed by the customer is a confirmation as to whether to use a bag that needs to be paid for.

12. (canceled)

13. The information processing system according to claim 1, wherein
the predetermined confirmation is a confirmation performed by a store clerk.

14. The information processing system according to claim 13, wherein
the confirmation performed by the store clerk is a confirmation indicating that the store clerk has collected a product of which the registration has been canceled through an operation of the customer among the registered products.

15. The information processing system according to claim 14, wherein
the at least one processor is further configured to execute the instructions to:
notify the store clerk to collect the product of which the registration has been canceled through the operation of the customer among the registered products, after registration of information on the products is completed and before the settlement for the registered products.

16. The information processing system according to claim 15, wherein
the at least one processor is further configured to execute the instructions to:
notify the store clerk that there is the product of which the registration has been canceled through the operation of the customer when the product is canceled.

17. The information processing system according to claim 15, wherein
the at least one processor is further configured to execute the instructions to:
notify a terminal device of the store clerk.

18. The information processing system according to claim 13, wherein
the confirmation performed by the store clerk is an age confirmation when any of the registered products is a product that requires the store clerk to confirm an age of the customer, and
the at least one processor is further configured to execute the instructions to:
notify the store clerk that the product requiring an age confirmation has been registered when the product requiring an age confirmation has been registered.

19. The information processing system according to claim 18, wherein
the at least one processor is further configured to execute the instructions to:
when the product requiring an age confirmation has been registered, notify the store clerk to perform an age confirmation after registration of information on the products is completed and before settlement for the products.

20. (canceled)

21. A method comprising:
receiving an input corresponding to a predetermined confirmation after registration of information on products to be purchased by a customer is completed through an operation of the customer and before settlement for the registered products; and
performing settlement for the registered products after the input corresponding to the predetermined confirmation is received.

22. A non-transitory computer-readable recording medium recording a program for causing a computer to execute:
receiving an input corresponding to a predetermined confirmation after registration of information on products to be purchased by a customer is completed through an operation of the customer and before settlement for the registered products; and
performing settlement for the registered products after the input corresponding to the predetermined confirmation is received.
